(19) United States
(12) Patent Application Publication
(10) Pub. No.: US 2006/0241858 A1
(43) Pub. Date: Oct. 26, 2006

(54) Digital map position information communication method, program for executing the same, program product therefor, system therefor, and apparatus therefor

(75) Inventor: Shinya Adachi, Kanagawa (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/565,899

(22) PCT Filed: Aug. 4, 2004
(86) PCT No.: PCT/JP04/11492

§ 371 Date: Jan. 25, 2006

(30) Foreign Application Priority Data
Aug. 4, 2003 (JP) 2003-285807
Feb. 4, 2004 (JP) 2004-028040

(51) Int. Cl. G01C 21/00

(52) U.S. Cl. 701/207; 701/208

(57) ABSTRACT

A transmission side transmits the road shape data of an object road 101 to be transmitted, and the branch shape data of a branch 20 intersecting with or branching from the object road 101. A reception side specifies the object road 101 on its own digital map with reference to the branch 20. In this method, the information indicating the shape of a branch or an intersection, which is liable to be erroneously identified, is transmitted as branch shape data to the reception side, so that the reception side can avoid the erroneous location identification. The branch shape 20 makes it possible to discriminate the object road 101 and a parallel road and to discriminate a discrepancy in the longitudinal direction of the object road 101, so that the erroneous location identification to the parallel road or the erroneous location identification in the longitudinal direction of the object road 101 can also be prevented.

### TECHNICAL FIELD

The present invention relates to a positional information transmission method for transmitting road positions on a digital map such as an object road of traffic information or a recommended route to a destination, and a program, a program product, a system and a device for executing the method, thereby to make it possible to transmit road positions precisely.

### BACKGROUND ART

Conventionally, the VICS (Vehicle Information and Communication System) provides services for providing road traffic information indicating the delay section and travel time through an FM multiplex broadcasting or beacon to a vehicular navigation device carrying a digital map database. The vehicular navigation device receives that road traffic information thereby to display the delay section in colors on a map displayed on a screen and to calculate and display the time period to reach the destination.

In case the road traffic information is thus provided, it is necessary to transmit the positional information of the road on the digital map. In the services for providing the information of a recommended route to reach the destination for the shortest time by receiving the information on the current place or the destination or in the road traffic information collection system (or the probe information collection system) for collecting the path information or speed information from a running vehicle (or a probe car) to exploit the collected information for creating the traffic information, it is necessary to transmit the recommended route or the traveled path on the digital map to the customer.

In the VICS, the road section is specified using the link number assigned to the road or the node number indicating a node such as a point of intersection.

The digital map data are made different in the data contents depending on its production company so that the scaled map never fails to have different data representing the road positions. Moreover, some map represents a trunk road in two lines of up and down roads, and another represents the trunk in one line. Here, the information of the link number and the node number used in the VICS are commonly contained in the digital map data of the individual producers. In the VICS, therefore, the road section can be precisely transmitted irrespective of the differences of the producers of the digital map data.

However, the node number and the link number defined in the road net have to be renumbered according to the renewal or change of the road so that the digital map data of the individual producers have to be accordingly updated. Therefore, the system using the node number and the link number takes a remarkable social cost for its maintenance.

In order to improve those points, JP-A-2001-041757 has proposed a method for transmitting the road position on the digital map without using the common node number or link number. In this method, a plurality of nodes p1, p2, - - - , and pN are set in a road section to be transmitted on the digital map of the transmission side, as shown in FIG. 30(a). These nodes can be exemplified by the nodes or interpolation points, which are set in the digital map data on the transmission side. As shown in FIG. 30(b), moreover, the “road shape data”, in which the plural nodes p1, p2, - - - , and pN are arrayed, are transmitted to the reception side. On the other hand, the reception side identifies the location of the individual node positions contained in the road shape data, on its own digital map thereby to specify the road section.

In order to facilitate the procedure on the reception side, on the other hand, JP-A-2001-066146 proposes that, in case a node p6 of a point of intersection is contained in the nodes set in the road section, as shown in FIG. 31(a), the information on the number and the connection angles α 1 and α 2 of the links to be connected to that node p6 is transmitted as additional information (FIG. 31(b)) together with transmission data of FIG. 30(b).

Moreover, JP-A-2003-023357 proposes a method, by which the road shape data are compressed and encoded to reduce the quantity of data. In this method, sampling points are reset at an interval of a constant distance on a road section to be transmitted (as called the “equidistance re-sample”), and the position data of the individual sampling points excepting the starting end are expressed by either a deflection angle θ j from the adjoining sampling point or a differential value Δ θ j of statistical predicted value (i.e., the difference between the predicted value predicted by using the deflection angle θ j and the deflection angles (θ j−1, θ j−2, - - - and so on) and the actual deflection angle θ j) and are encoded to variable long codes. These encoded data and the latitude/longitude data of the starting end are transmitted to the reception side. The reception side decodes the encoded data and restores the position data of the individual sampling points thereby to specify the road section.

In the positional information transmission method, in which the transmission side transmits the road shape data and in which the reception side conduct the location identification to specify the road section, the reception side may specify the erroneous place at a parallel road or at a branching portion of a small angle. Especially in the place where a highway and a general road take a multi-layered structure or at a branching portion from the trunk such as an interchange or a transfer ramp/connection road, a mistaken place is highly probably specified. As to the multi-structure, by referring the “road type code” which is described in JP-A-2001-066146, the probability of erring the location identifications can be drastically reduced since the multi-layered roads are hardly composed of roads of the same type. However, this method is not effective means at the branching portion from the trunk such as the transfer ramp or the connection road, because roads of the same type run adjacent and parallel to the trunk. Especially, in case one map represents the road in two lines of up and down roads whereas another map represents the road in one line of two ways, the error in the location identification frequently occurs when the positional information is transmitted between the two maps.

### DISCLOSURE OF THE INVENTION

The present invention has an object to provide a positional information transmission method capable of preventing an error in the location identifications on the reception side, to which road shape data of an object road are transmitted, and a program, a program product, a system and a device for executing the method.

According to the invention, there is provided an positional information transmission method of transmitting positional information from a transmission side to a reception side provided with a digital map, comprising the steps of: forming, on the transmission side, position codes based on object road shape data of a transmission object road and assistance shape data of a road to be connected to the object road; and transmitting the position codes from the transmission side to the reception side.

The object road shape data and the connection positional information of the assistance shape data may also be added to the position codes. The connection positional information may also be expressed with the number of points composing the object road shape data.

Moreover, the attribute information for discriminating the object road shape data and the assistance shape data may also be added to at least one of the object road shape data and the assistance shape data. Moreover, the road attribute information of the assistance shape data may also be added to the position codes. Here, at least one of a road type, a link type, a road number, a road name, a passing direction, an altitude, a road opening year can be used as the road attribute information of the assistance shape data.

According to the invention, moreover, there is provided positional information decoding method of decoding positional information of a digital map, comprising the steps of: receiving position codes including object road shape data of a transmission object road and assistance shape data of a road to be connected to the object road; and specifying the object road on the digital map with reference to the object road shape data and the assistance shape data.

The step of specifying the object road on the digital map may include: the step of deciding a similarity of the shape of the object road shape data and the assistance shape data, to an object road candidate for the object road shape data and an assistance candidate for aid assistance shape data; and the step of finally selecting the object road candidate for the object road on the basis of the decision result.

Moreover, the step of specifying the object road on the digital map may include: the step of searching the point corresponding to the connection position between the object road shape data and the assistance shape data, on the digital map; and the step of correcting the position of an object correlated to one of the object road shape data and the assistance shape data, with reference to the position of the point.

Moreover, the step of specifying the object road on the digital map may include: the step of correcting, in case at least a partial section of the object road shape data is absent on the digital map, the position or shape of the absent section of the object road shape data, with reference to the assistance shape data.

According to the invention, moreover, there is provided a positional information creation method of creating the position informational of a digital map, comprising the steps of: creating object road shape data which is shape data of a transmission object road; and adding assistance shape data which shape data of a connection road to be connected to the object road, to the object road shape data thereby to create position codes.

The assistance shape data may be added to the object road shape data, in case the connection angle between the connection road and the object road is within a predetermined angle or in case the shape of the connection road from the connection position to a predetermined position and the shape of the object road are parallel and similar to each other.

The assistance shape data may also be added to the object road shape data in case another parallel and similar road is present in the periphery of the object road. The connection road may also be discriminated with at least one of its connection position, shape and assistance.

In case the object road contains a section having a high probability of being absent from the transmission destination of position codes, the connection road to be connected to the section and having a high probability of being present in the transmission destination may also be incorporated as assistance shape data into position codes. Moreover, the probability of the object road being present at the transmission destination may also be discriminated with the opening year of the road. Moreover, the probability of the object road being present at the transmission destination may be discriminated with the type of the road.

According to the invention, moreover, there is provided a positional information decoding method of decoding positional information of a digital map, comprising the steps of: receiving position codes composed of object road shape data of a transmission object road and assistance shape data of a road to be connected to the object road; separating the object road shape data and the assistance shape data; and specifying the object road on the digital map with reference to the object road shape data.

According to the invention, moreover, there is provided a positional information specifying method using the information, which is composed at least shape data of a rod and assistance shape data of a road to be connected to the road, so as to specify a position on a digital map on a reception side.

According to the invention, moreover, there is provided a positional information transmission method of transmitting positional information from a transmission side to a reception side provided with a digital map, comprising the steps of: (A) creating, on the transmission side, object road shape data of a transmission object road and a branch shape data of a branch intersecting with or branching from the object road; (B) transmitting the object road shape data and the branch shape data from the transmission side to the reception side; and (C) specifying, on the reception side, the object road on the digital map with reference to the object road shape data and the branch shape data.

In this positional information transmission method, the information indicating the shape of a branch or an intersection, which is liable to be erroneously identified, is transmitted as branch shape data to the reception side, so that the reception side can avoid the erroneous location identification. Even in case the transmission side holds the digital map data of a two-line road representation form whereas the reception side holds the digital map data of a one-line road representation form, the location identification error can be prevented. The branch shape makes it possible to discriminate the object road and a parallel road and to discriminate a discrepancy in the longitudinal direction of the object road. Therefore, the erroneous location identification to the parallel road or the erroneous location identification in the longitudinal direction of the object road can also be prevented.

The (C) step of the aforementioned positional information transmission method may include: (c1) the first location identification step of selecting an object road candidate for the object road from the digital map with reference to the object road shape data; (c2) the second location identification step of selecting a branch candidate for the branch from the digital map with reference to the branch shape data, with the assumption that the object road candidate is the object road; (c3) the step of repeating the (c1) step and the (c2) step to select a plurality of combinations of the object road candidate and branch candidate; and (c4) the step of finally selecting the object road candidate to become the object road, from the plural combinations.

Here, the (c4) step may also include: the step of deciding the similarities between the shapes of the object road candidate and the branch candidate and the original shapes of the object road and the branch; and the step of finally selecting the object road candidate to become the object road, on the basis of the decision result.

Moreover, in case the branch shape data are created at the (A) step on the basis of the relative position relation, the reference data to refer to the road shape data may also be contained in the branch shape data.

Moreover, at the (c2) step, the branch candidate may also be selected using the reference data.

Moreover, the (c4) step may also include: (1) the step of calculating a first vector between points spaced at an equidistance from the point of intersection between the original shapes of the object road and the branch and lying on the object road and the branch; (2) the step of repeating the first vector calculating step at every plural distances from the point of intersection, to acquire a plurality of first vectors; (3) the step of calculating a second vector between points spaced at an equidistance from the point of intersection between the object road candidate and the branch candidate and lying on the object road candidate and the branch candidate; (4) the step of repeating the second vector calculating step at every plural distances from the point of intersection and in every plural combinations, to acquire a plurality of second vectors; and (5) the step of calculating the differences between the plural first vectors and the plural second vectors in every the combinations, to finally select the object road candidate of the combination the smallest in the difference, as the object road.

Moreover, the (c4) step may also include: (1) the step of calculating a first angle made between the original shape of the object road and the original shape of the branch; (2) the step of calculating a second angle between the object road candidate and the branch candidate in every of the combinations; and (3) the step calculating the difference between the first angle and the second angle in every of the combinations, to finally select the object road candidate of the combination the smallest in the difference, as the object road.

Moreover, there may also be further comprised: the step of searching, after the (c1) step and the (c2) step, the branching point, at which the object road candidate and the branch candidate branch, on the digital map; and the step of correcting the shape of the branch candidate to the shape to branch at the branching point with respect to the object road candidate.

Moreover, there may also be further comprised: the step of searching, after the (c1) step and the (c2) step, the branching point, at which the extensions of the object road candidate and the branch candidate branch, on the digital map; and the step of correcting the shape of the branch candidate to the shape to branch at the branching point with respect to the object road candidate.

Moreover, the position of event information correlating to the object road shape data and the branch shape data may also be corrected with reference to the corrected shape of the branch candidate.

Moreover, the road intersecting with or branching from the object road may also be set as the branch, in case the angle between the road and the object road is within a predetermined angle range and in case the shape of the road at a predetermined distance from the intersecting position or the branching position is similar to the shape of the object road.

According to the invention, moreover, there is provided a program for causing an information providing device to provide positional information for a digital map, wherein the program causes the information serving device to execute: a procedure for extracting object road shape data corresponding to a transmission object road, from a digital map database; a procedure for extracting branch shape data corresponding to a branch intersecting with or branching from the object road, from the digital map database; and a procedure for transmitting the object road shape data and the branch shape data extracted, to the outside.

According to the invention, moreover, there is provided a program product for causing an information serving device to provide positional information for a digital map, comprising: a recording medium; and a program recorded in the recording medium, wherein the program causes the information serving device to execute: the procedure for extracting object road shape data corresponding to a transmission object road, from a digital map database; the procedure for extracting branch shape data corresponding to a branch intersecting with or branching from the object road, from the digital map database; and the procedure for transmitting the object road shape data and the branch shape data extracted, to the outside. There is also provided a program product having the program recorded on a recording medium.

According to the invention, moreover, there is provided a positional information transmission system for a digital map, comprising: (A) an information providing device; and (B) an information application device, wherein the (A) information providing device includes: an object road shape data extraction unit for extracting an object road shape data corresponding to a transmission object road, from a first digital map database; and a branch shape data extraction unit for extracting branch shape data corresponding to a branch intersecting with or branching from the object road, from the first digital map database, and wherein the (B) information application device includes: an object road candidate selection unit for selecting an object road candidate from a second digital map database with reference to the object road shape data provided from the information providing device; a branch candidate selection unit for selecting a branch candidate from the second digital map database with reference to the branch shape data provided from the information providing device; and an object road decision unit for finally selecting the object road candidate to be the object road, with reference to the object road candidate and the branch candidate.

According to the invention, moreover, there is provided an information providing device for providing positional information for a digital map, comprising: a digital map database; an object road shape data extraction unit for extracting an object road shape data corresponding to a transmission object road, from a digital map database; a branch shape data extraction unit for extracting branch shape data corresponding to a branch intersecting with or branching from the object road, from the digital map database; and a shape data transmission unit for transmitting the object road shape data and the branch shape data extracted, to the outside.

According to the invention, moreover, an information application device for receiving and utilizing positional information for a digital map, comprising: a digital map database; a shape data reception unit for receiving object road shape data of an object road and branch shape data corresponding to a branch intersecting with or branching from the object road, from the outside; an object road candidate selection unit for selecting an object road candidate from the digital map database with reference to the object road shape data; a branch candidate selection unit for selecting a branch candidate from the digital map database with reference to the branch shape data; and an object road determination unit for finally selecting the object road candidate to become the object road, with reference to the object road candidate and the branch candidate.

The digital map positional information transmission method of the invention can prevent the erroneous matching to the branching road, the intersection and the parallel road on the reception side, or the erroneous matching in the longitudinal direction of the object road thereby to transmit the positional information of the digital map precisely. Even in case the transmission side and the reception side hold digital map data of different road representation forms or different scales, the erroneous matching can be prevented.

Moreover, the program, the program product, the system and the device of the invention can execute the positional information transmission method.

### BRIEF DESCRIPTION OF THE DRAWINGS

FIG. 1 presents diagrams for explaining object roads and branches to be transmitted by a positional information transmission method in a first embodiment of the invention;

FIG. 2 presents diagrams for explaining another example of the object roads and branches to be transmitted by the positional information transmission method in the first embodiment of the invention;

FIG. 3 is a diagram for explaining a location identification in the first embodiment of the invention;

FIG. 4 presents diagrams showing the object road candidates obtained by the location identification in the first embodiment of the invention;

FIG. 5 presents diagrams showing the object road candidates to be excluded from the object in the branch location identification in the first embodiment of the invention;

FIG. 6 presents diagrams showing the branch candidates obtained in the branch location identification in the first embodiment of the invention;

FIG. 7 presents diagrams showing the object road candidate and the branch candidate obtained by the location identification in the first embodiment of the invention;

FIG. 8 presents diagrams for explaining a method for locating the object road candidate in the first embodiment of the invention;

FIG. 9 presents the object road candidate identified by location identification and the original shape in the first embodiment of the invention;

FIG. 10 is a diagram showing branches to be transmitted by a location information transmission method in the first embodiment of the invention;

FIG. 11 is a block diagram showing a configuration of a positional information transmission system in the first embodiment of the invention;

FIG. 12 is a flow diagram showing the operations of the transmission side of the positional information transmission system in the first embodiment of the invention;

FIG. 13 is a diagram for explaining the object road and the branches to be transmitted by the positional information transmission system in the first embodiment of the invention;

FIG. 14 is a diagram showing shape data to be transmitted by the positional information-transmission system in the first embodiment of the invention;

FIG. 15 is a flow chart showing the operations of the reception side of the positional information transmission system in the first embodiment of the invention;

FIG. 16 present diagrams for explaining a method for evaluating the location identification results on the reception side of the positional information transmission system in the first embodiment of the invention;

FIG. 17 presents diagrams for explaining a method for evaluating a location identification result in a second embodiment of the invention;

FIG. 18 presents diagrams for explaining a method for evaluating a location identification result in a third embodiment of the invention;

FIG. 19 presents diagrams showing shape data in the third embodiment of the invention;

FIG. 20 presents diagrams showing shape data in a fourth embodiment of the invention;

FIG. 21 presents diagrams showing a location identification method in the fourth embodiment of the invention;

FIG. 22 presents diagrams showing shape data in a fifth embodiment of the invention;

FIG. 23 is a diagram for explaining the differences in the road shape between maps of different scales;

FIG. 24 is a diagram for explaining a location identification method in a sixth embodiment of the invention;

FIG. 25 presents diagrams for explaining a branch shape correcting operation in the sixth embodiment of the invention;

FIG. 26 is a flow chart showing a branch shape correcting procedure in the sixth embodiment of the invention;

FIG. 27 presents diagrams contrasting the case (b), in which the reception side displays an event position without correction of a branching position, and the case (c), in which the event position is displayed on the basis of the branching position corrected by the method in the sixth embodiment of the invention;

FIG. 28 presents diagrams for explaining a road shape adding operation in the sixth embodiment of the invention;

FIG. 29 is a flow chart showing a shape data creating operation on the transmission side in the sixth embodiment of the invention;

FIG. 30 presents diagrams showing the shape data to be transmitted by the positional information transmission method of the prior art;

FIG. 31 presents diagrams showing another example of the shape data to be transmitted by the positional information transmission method of the prior art;

FIG. 32 presents diagrams for explaining maps representing a grade-separation intersection road in a double-line representation form;

FIG. 33 is a diagram for explaining a map representing a grade-separation intersection road in a single-line representation form;

FIG. 34 presents diagrams for explaining the location identifications in maps of different representation forms;

FIG. 35 is a diagram showing the result of an erroneous location identification;

FIG. 36 is a diagram showing a modification of the shape data of FIG. 14;

FIG. 37 presents diagrams showing locating procedure on the transmission side and on the reception side in a seventh embodiment of the invention;

FIG. 38 presents diagrams showing a shape correction of a section absent from the reception side in the seventh embodiment of the invention;

FIG. 39 is an example of a digital map, to which an eighth embodiment of the invention is applied;

FIG. 40 is a diagram showing such a connection road to an object road as is used as assistance shape data, in the eighth embodiment of the invention; and

FIG. 41 is a flow chart showing the operations of the reception side of the positional information transmission system in the ninth embodiment of the invention.

### BEST MODE FOR CARRYING OUT THE INVENTION

### First Embodiment

In a positional information transmission method of an embodiment of the invention, a transmission side transmits not only a road shape data of an object road at which error of the location identification tends to occur but also shape data of either a branching portion of a road branched at a predetermined angle from the object road or a portion which intersects with the object road (both the places will be called together the “branch”) as assistance information or reference information. In short, the “branch” is a road (or a connection road) connected to a road of a main object to be transmitted (i.e., the object road). The reception side specifies the object road with reference to the branch shape at time of the location identification. The “location identification” defines an act of specifying the position of the object road on a digital map or identifying the corresponding road on the digital map. This also includes a concept of so-called “map matching and the “pattern matching”. The shape data of the above-described branch is generally called the “assistance shape data” and “reference shape data”, and includes a concept of so-called “branch shape data”. These “assistance shape data” and “reference shape data” are the concept of the data for a specific assistance or reference of the object road, i.e., the main object of the location identification. The following description uses the terminology of the “branch shape data”, which can be extended to the concept of the “assistance shape data” or the “reference shape data”.

Here is described an example of the case, in which the invention is especially useful.

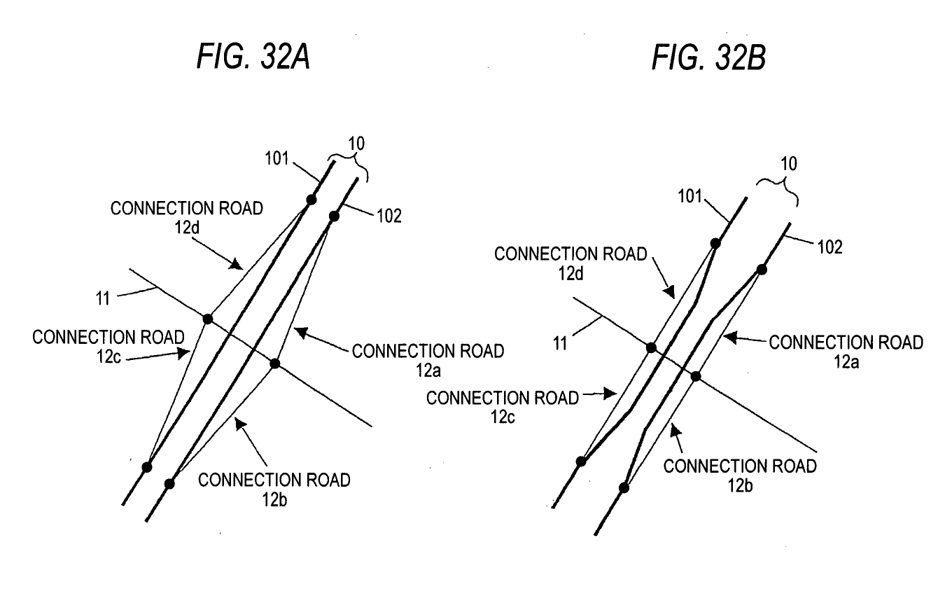

In a digital map representing trunks in double lines, as shown in FIG. 32(a), roads are displayed by: a trunk 10 composed of double lines of an up road 102 and a down road 102; a road 11 passing below the trunk 10 at a grade-separation point; and transfer ramps 12a, 12b, 12c and 12d connecting the trunk 10 and the road 11. Alternatively, the roads are displayed, as shown in FIG. 32(b).

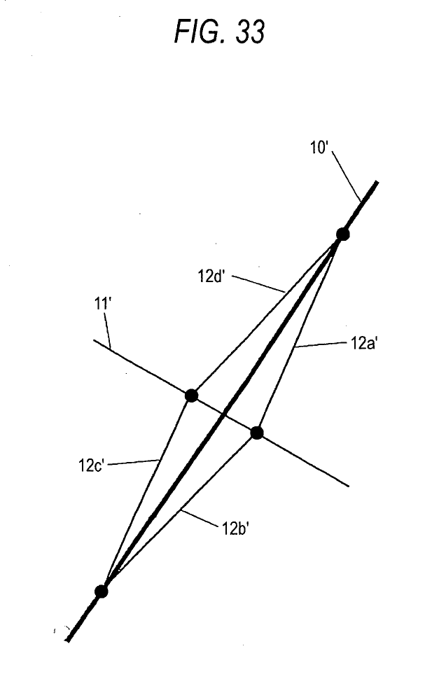

In a digital map representing roads in a single line, on the other hand, a trunk 10′, a road 11′ passing under the trunks 10′, and transfer ramps 12a′, 12b′, 12c′ and 12d′ are individually represented by a single line, as shown in FIG. 33.

Now, it is assumed that the transmission side having the digital map represented, as shown in FIG. 32(a) or 32(b), transmits the road shape data of the up road 101 or the down road 102 to the reception side having the digital map represented as shown in FIG. 33.

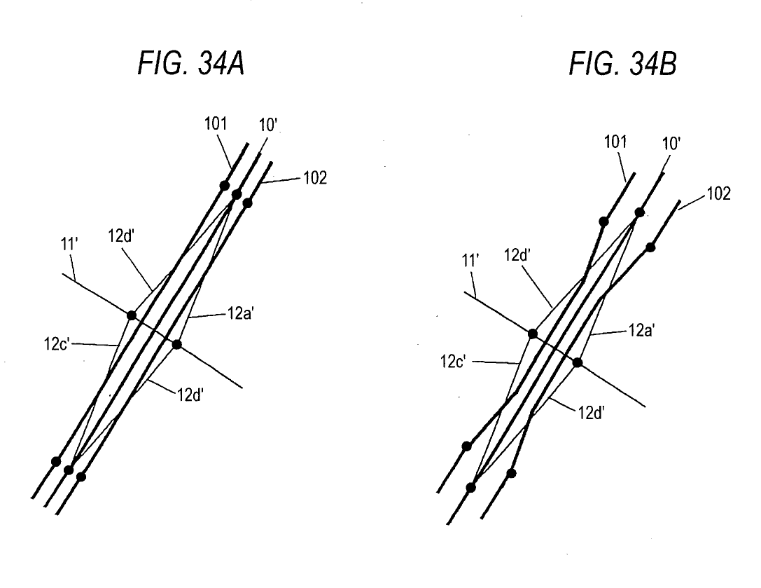

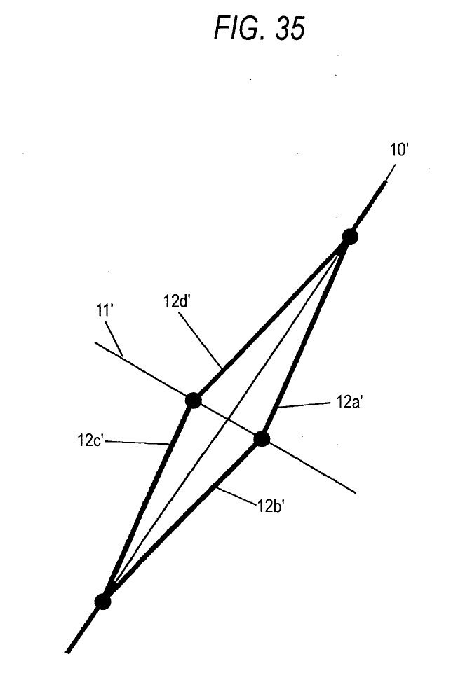

FIGS. 34(a) and 34(b) schematically show the location identification to be done at this time on the reception side. FIG. 34(a) shows diagram in which the up road 101 and the down road 102 of the trunk 10 of FIG. 32(a) is superimposed on the digital map of the receiving side shown in FIG. 33. Since a road close to the trunks 10 is selected from the roads contained in the digital map of FIG. 33, no matter whether the shape data of the up road 101 or the down road 102 of the trunks 10 might be selected, the transfer ramps 12a′ and 1.2c′ or the transfer ramp 12b′ and 12d′ are erroneously identified, as shown in FIG. 35. As shown in FIG. 34(b), on the other hand, the up road 101 and the down road 102 of the trunks 10 of FIG. 32(b) are superposed on the digital map of the reception side shown in FIG. 33. In this case, the transfer ramps 12a′, 12b′, 12c′ and 12d′ closer to the trunks 10 than the trunks 10′ are also erroneously identified.

The embodiment of the invention is described in the following.

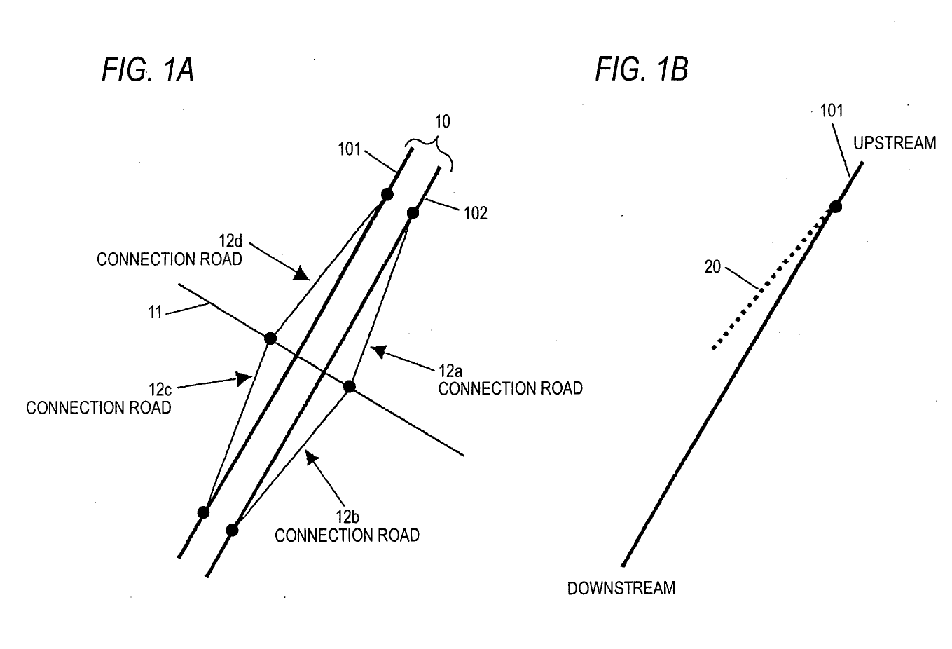

In case the transmission side has a digital map adopting the double-line representation form, when the transmission side transmits the road shape data of the up road 101 around the grade-separation intersection as shown in FIG. 1(a), for example, the transfer 12d which tends to be erroneously identified is assumed to be a branch 20, and the branch shape data representing a shape of the branch 20 is transmitted with the road shape data (object road shape data) of the up road 101. Incidentally, it is assumed that in the road shape data of the up road 101, the position data of individual nodes are arrayed sequentially from the nodes on the upstream side. In this case, sine the transfer ramp 12d branches at a small angle with respect to the data array of the up road 101, the transfer ramp 12d is assumed to be the branch 20. In the road shape data of the up road 101, a transfer ramp 12c is assumed to be the branch in case the position data of the individual nodes are arrayed sequentially from the downstream.

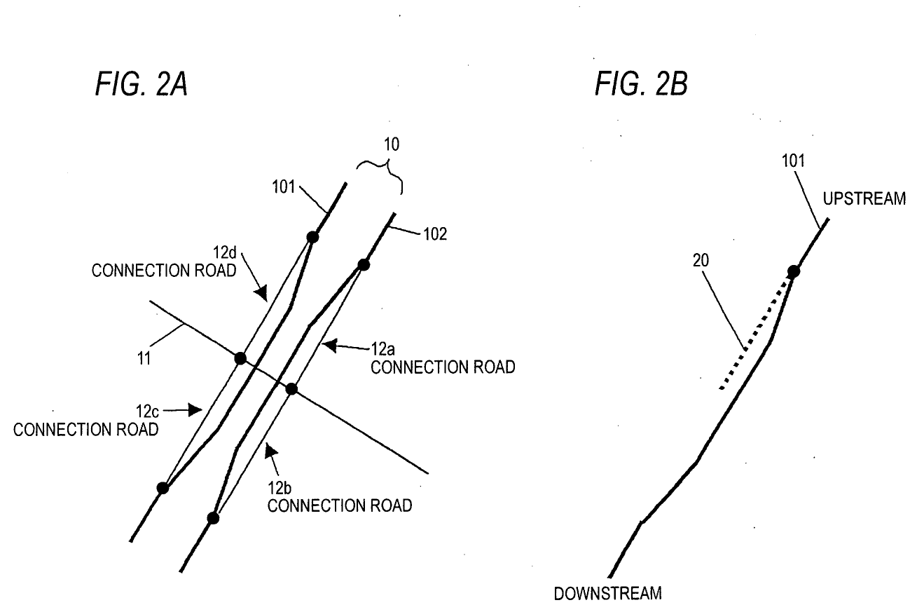

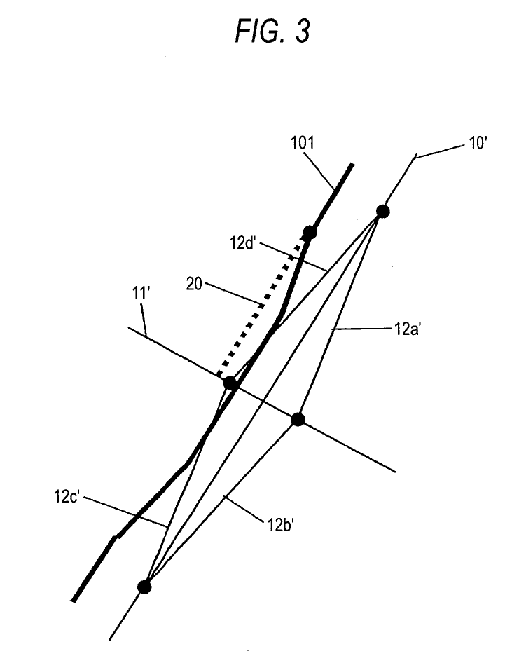

On the other hand, FIG. 2(b) shows the object road shape data and the branch shape data at the time when the transmission side having a digital map of FIG. 2(a) takes the up road 101 as its object road.

Moreover, there is information called the “position codes” which relates to a place for specifying the road or place on the map. In the present invention, the “position codes” involves a concept of at least both the object road shape data and the branch shape data.

On the other hand, the reception side having received the road shape data and the branch shape data (i.e., the position codes) specifies the object road in the following method.

(1) Selection of Object Road Candidates

In case the reception side has a digital map of FIG. 33 adopting the representation form of the single line, the object road 101 represented by the road shape data and the branch 20 represented by the branch shape data are superposed on the digital map, and the object road 101 is firstly identified and the road (i.e., the object road candidate) to become a candidate for the object road is selected. Specifically, there is executed a first location identification step of selecting the object road candidate from the object roads from the digital map with reference to the object road shape data.

(2) Selection of Branch Candidates

Next, the candidate (or the branch candidate) for the branch 20 at the time when the individual candidate roads (i.e., the object road candidates) are assumed to be the object road 101 is determined by conducting location identification on the branch 20 while excluding the candidate road (i.e., the object road candidate) of the object road 101 from the object. Specifically, there is executed a second location identification step of selecting a branch candidate of the branch from the digital map with reference to the branch shape data on the basis of the assumption that the object road candidate is the object road.

(3) Selection of Combination of Plural Object Road

Candidates and Branch Candidates

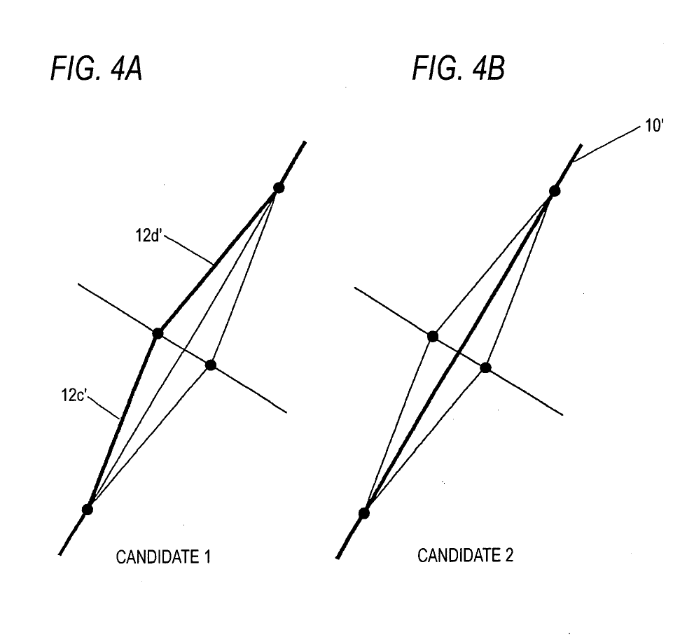

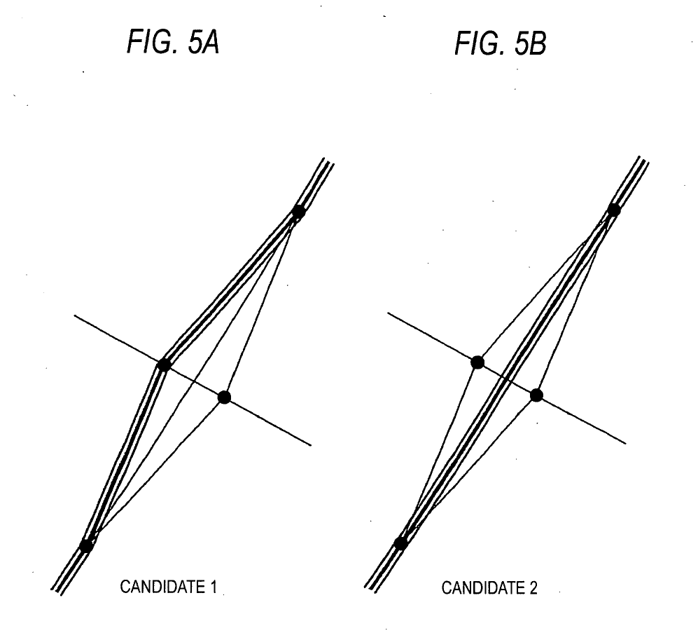

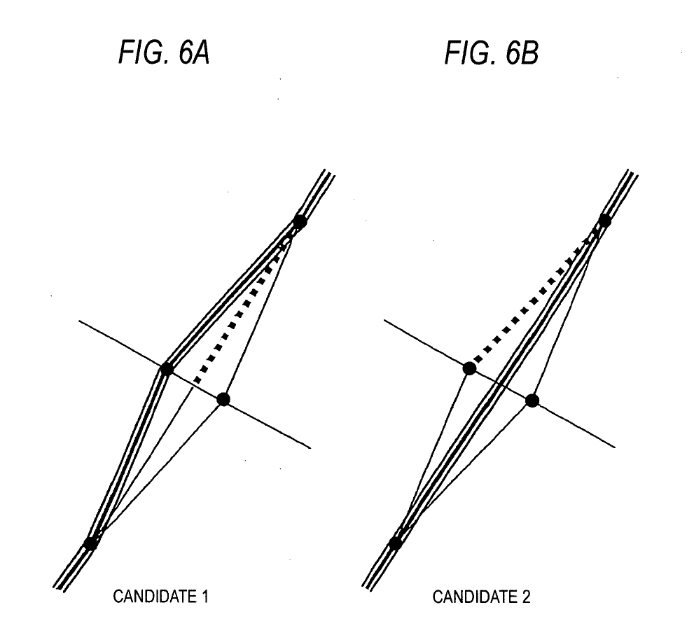

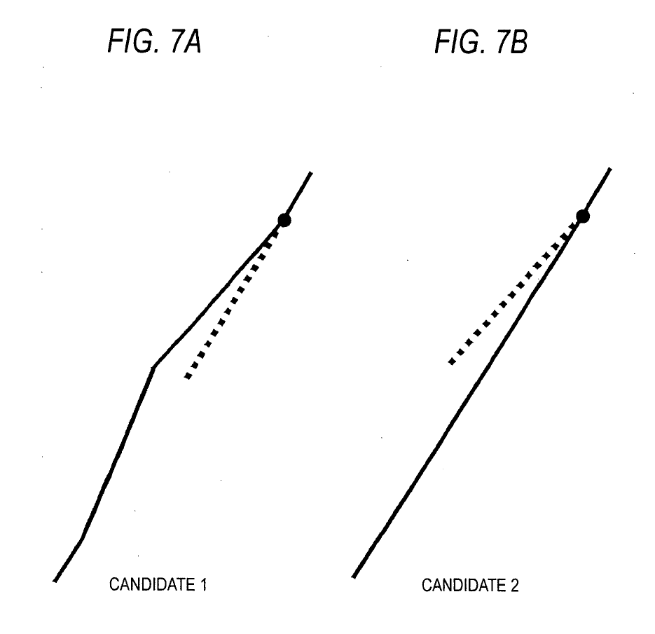

In the location identification of the object road 101, as shown in FIG. 4, the transfer ramps 12d′ and 12c′ the closest to the object road 101 are selected as a candidate 1 (FIG. 4(a)), and the trunk 10′ the second-closest to the object road 101 is then selected as a candidate 2 (FIG. 4(b)). In short, there are selected a plurality of combinations of the object road candidates and the branch candidates. In other words, the step of selecting the plural combinations of the object road candidates and the branch road candidates is executed by repeating the first location identification step and the second location identification step. In the location identification of the branch 20, the candidate for the branch 20 is determined from roads except the road of the candidate 1 for the object road 101 at the time that that the candidate 1 is assumed to be the object road 101, as shown in FIG. 5(a), and the candidate for the branch 20 is determined from roads excepting the road of the candidate 2 for the object road 101 at the time that the candidate 2 is the object road 101, as shown in FIG. 5(b). As shown in FIG. 6, in case the transfer ramps 12d′ and 12c′ are to be the candidate for the object road 101, the result is that the truck 10′ is the candidate for the branch 20 (FIG. 6(a)). In case the truck 10′ is to be the candidate for the object road 101, the result is that the transfer ramp 12d′ is the candidate for the branch 20 (FIG. 6(b)). FIGS. 7(a) and 7(b) extract and show the results of the location identifications of the object road 101 and the branch 20.

(4) Comparison of Original Shape and Candidate

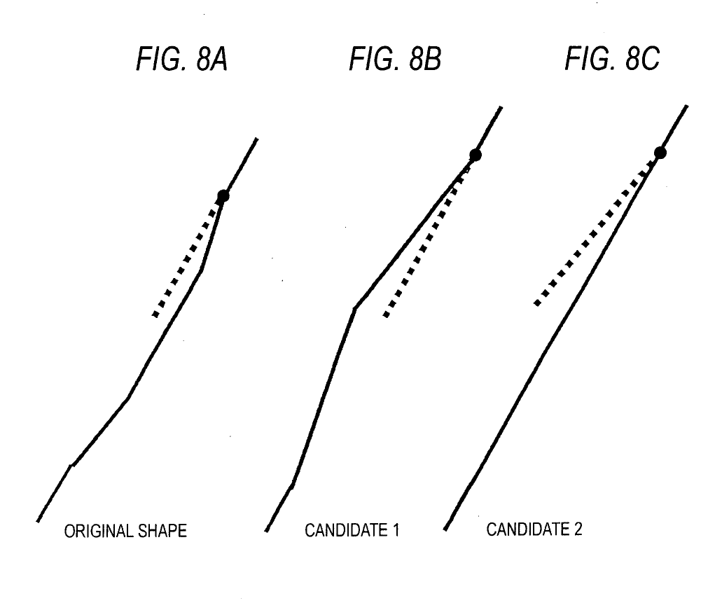

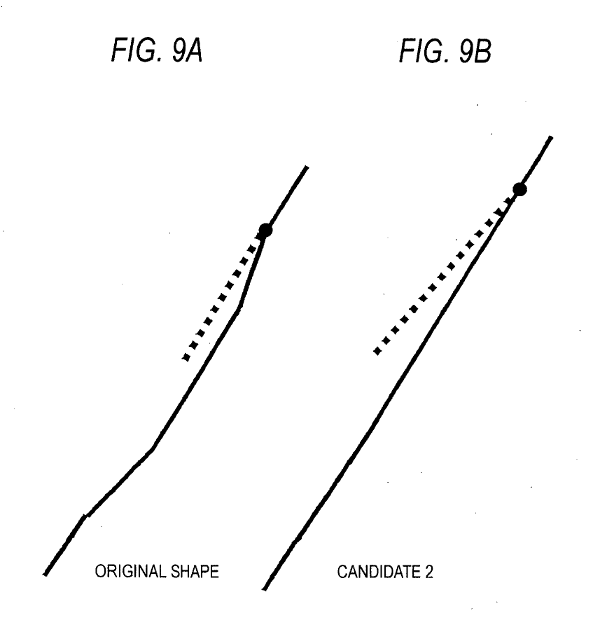

Next, the location identification results (b) and (c) and the shape (a) of the original object road 101 and the branch 20 are compared, as shown in FIG. 8, and the candidate 2 having high similarity therewith is selected as the object road, as shown in FIG. 9. The detail of this similarly evaluation method will be described hereinafter. In short, there is executed the step of finally selecting the object road candidate for the object road, from the plural combinations determined in the above. More specifically, there are executed the step of deciding the similarity between the shape of the object road candidate and the branch candidate and the original shape of the object road and the branch, and the step of finally selecting the object road candidate as the object road on the basis of that decision result. Thus, the transmission side transmits the road shape data of the object road and the branch shape data of a branch which tends to be erroneously identified, so that the object road can be precisely identified on the digital map of the reception side even in case the reception side has the digital map adopting the single-line representation form different from that of the transmission side.

Here, the error in the location identification tends to occur in such a portion, e.g., not only a grade-separation transfer ramp but also a connection road connecting parallel roads at a small intersection angle and a section which branches or intersect at a small angle (e.g., about 10 degrees or less) and runs a distance in parallel, such as the entrance or exit of an interchange (although this exists among the trucks sometime). The positional information location identification method of this embodiment is remarkably effective for prevent a specific error at the position such as the above.

Even if a branch has a large branching angle from a trunk just after having branched but if the branch then curves forms a small angle with the trunk, error in the location identification of the branch tends to occur (because the object road is specified by conducting the location identification on the nodes or sampling points which is set apart from each other). Therefore, when using the term the “angle” of the branch, this indicates the angle between a portion of the branch within a predetermined length from the branching point and occupying the length of a considerable portion thereof, and the trunk.

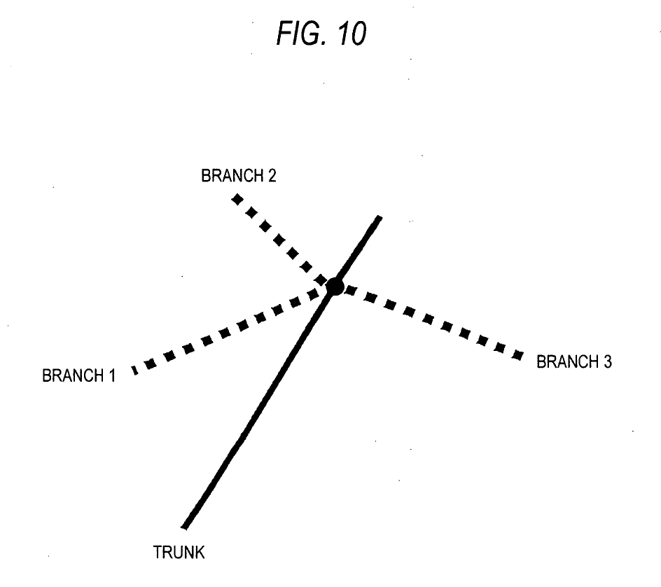

Moreover, the number of branches from the branching point should not be limited to one but may be plural, as shown in FIG. 10.

Moreover, the branch shape data need not includes the whole shape of the branch until another road but may contain only the data representing the shape to the midway of the branch.

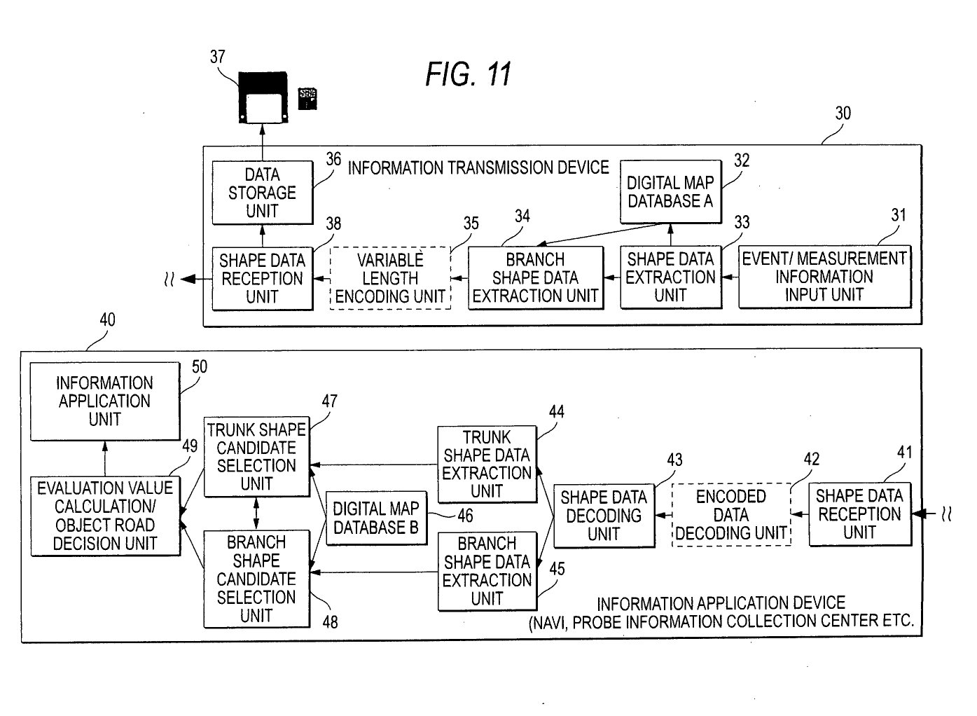

FIG. 11 shows a configuration of a system for executing the positional information transmission method.

This system includes an information transmission device 30 as an information providing device for transmitting the road shape data and the branch shape data of an object road, and an information application device for receiving the information to reproduce the object road. The information transmitting device 30 is a center providing traffic information including information of the object road section and recommended route information to the destination, and the information application device 40 is a car navigation system which uses and put the information in practice. Alternatively, the information transmission device 30 is a probe car mounted device for providing traveled path information together with measured information such as a speed, and the information application device 40 is a probe information collection center for collecting the information from each probe car to use it for generating the traffic information.

The information transmission device 30 constitutes so-called “transmission side”, and the information application device 40 constitutes so-called “reception side”. However, the detailed structure of these are not limited to the embodiment. It is sufficient that the “transmission side” can send/transmit the shape data, and that the “reception side” can receive/accept the shape data. The information transmission device 30 is provided with: a digital database A 32; an event information input unit 31, to which delay information or traffic accident information is inputted; a shape data extraction unit 33 for extracting road shape data of an object road section from a (first) digital map database A 32; a branch shape data extraction unit 34 for selecting the branch in the object road section and extracting the branch shape data from the digital map database A 32; a variable length encoding unit 35 for compressing and encoding the road shape data and the branch shape data according to need; a data storage unit 36 for storing the road shape data and the branch shape data and providing the stored data to an external media 37; and a shape data transmission unit 38 for transmitting the road shape data and the branch shape data.

On the other hand, the information application device 40 is provided with: a (second) digital map database B 46; a shape data reception unit 41 for receiving the road shape data and the provided branch shape data; an encoded data decoding unit 42 for decoding the data, if compressed and encoded; a shape data decoding unit 43 for decoding the position data of the nodes or sampling points contained in the road shape data and the branch shape data; a trunk shape data extraction unit 44 for extracting the position data of the nodes or the sampling points of the object road from the decoded data; a branch shape data extraction unit 45 for extracting the position data of the nodes and sampling points of the branch from the decoded data; a trunk candidate selection unit 47 for selecting the candidate of the object road from the map data of the digital map database B 46 by location identifications with the data extracted by the trunk shape data extraction unit 44; a branch shape candidate extraction unit 48 for selecting the candidate of the branch from the map data of the digital map database B 46 by location identifications with the data extracted by the branch shape data extraction unit 45; an evaluation value calculation/object road decision unit 49 for determining the object road on the basis of the evaluation value indicating a similarity to the original shape; and an information application unit 50 for utilizing information on the object road.

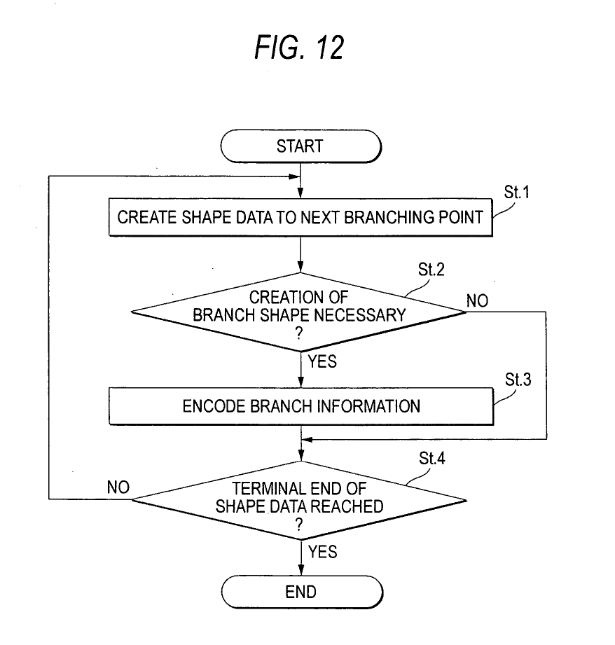

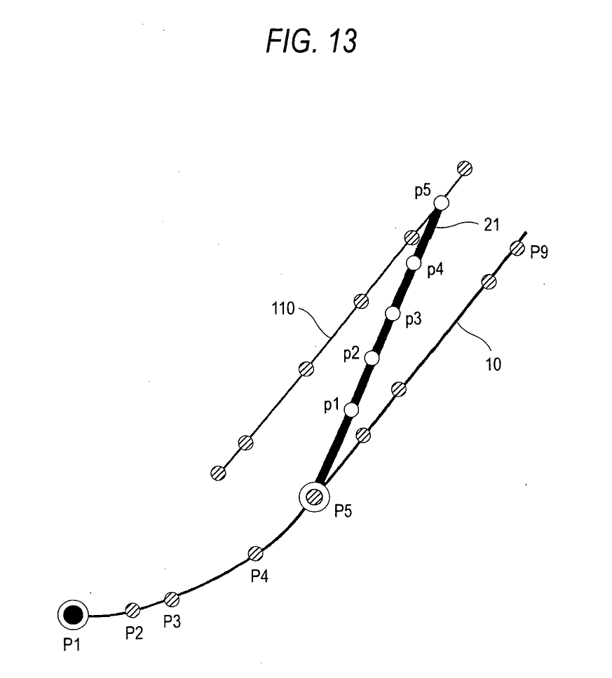

The flow diagram of FIG. 12 shows the operation procedures of the shape data extraction unit 33 and the branch shape data extraction unit 34 of the information transmission device 30. It is now assumed, as shown in FIG. 13, that nodes P1 to P9 of the road 10 belong to the object road, and that a connection road 21 to a parallel road 110 branches from the node P5 of the object road 10.

The shape data extraction unit 33 creates the road shape data (at Step 1) by extracting the position data of the nodes of the object road 10 from P1 to P5, where the connection road 21 branches, from the digital map database A 32. The branch shape data extraction unit 34 decides (at Step 2) whether or not it is necessary to set the connection road 21 branching from the branching point P5, as a branch. In this decision, it is checked whether or not the shape of the connection road 21 extending from the branching point P5 matches the following condition (1) or (2). In case this answer is Yes, the connection road 21 is determined as the branch.

(1) The relative branching angle with respect to object road is within ±θ.

(2) The shape of the branch from the branching point by a predetermined distance L is similar to the object road.

The aforementioned case corresponds to such a case that the object road and the branch (or the connection road) run in parallel from the connection position to a predetermined position and are similar in shape.

In case the branch shape data are created on the basis of the positional relation between the object road and the branch, as in the aforementioned cases (1) and (2), the branch shape data can be structured to contain the reference data to be referred to the object road shape data.

The branch shape data extraction unit 34 creates the branch shape data (at Step 3) by extracting the position data of the nodes p1, p2, p3, p4 and p5 set on the connection road 21 from the digital map database A 32, in case it is necessary to set the branching connection road 21 as the branch. The branch shape data are not creased if it is not necessary to set the connection road 21 as the branch.

If the branching point P5 is not the terminal of the object road (at Step 4), the routine returns to Step 1 and the shape data extraction unit 33 creates the road shape data to the next branching point, and the operations of Step 1 to Step 3 are repeated till the terminal P9 of the object road is reached.

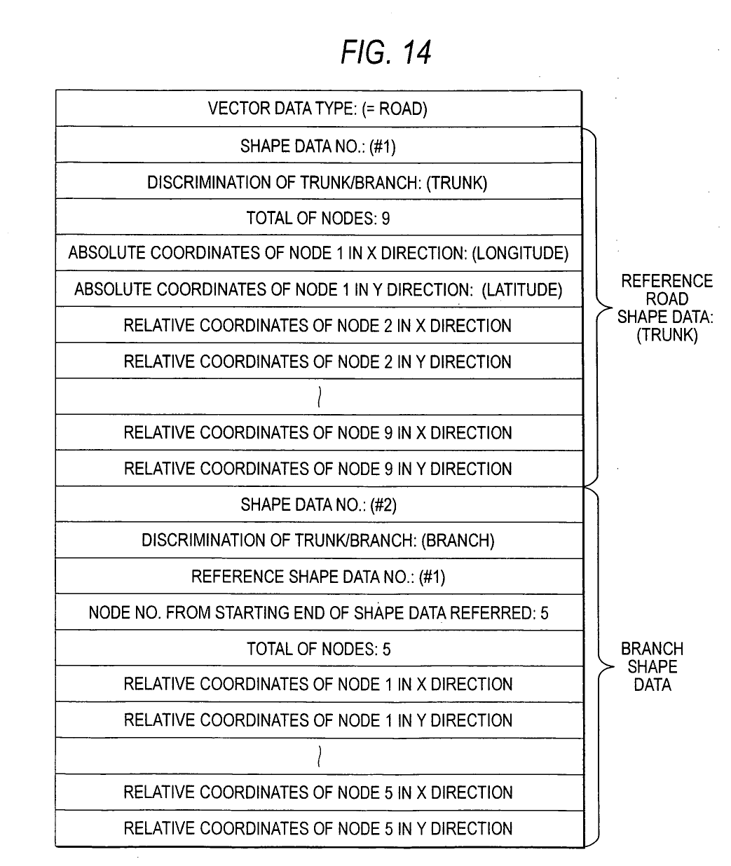

By these operations, the road shape data (i.e., the road shape data referred) of the object road and the branch shape data relating to the object road shape data are created (by an encoding operation), as shown in FIG. 14. In FIG. 14, the “Shape Data No. to Re referred” or the “Node No. from Starting Point of Reference Shape Data” correspond to the so-called “reference data” or the “connection positional information”. Therefore, the “connection positional information” can be expressed by the “Node No. from Starting Point of Shape Data”, that is, by the point number composing the object road shape data. Moreover, the attribute information for discriminating the object road shape data and the branch shape data (i.e., the assistance shape data), that is, the “Discrimination of Trunk/Branch (Trunk or Branch)” is contained in both the object road shape data and the branch shape data. This attribute information may be contained in only one of the object road shape data and the branch shape data. The shape data transmission unit 38 of the information transmission device 30 transmits those shape data.

Here, the position data of the nodes are expressed in absolute coordinates and in relative coordinates but can also be expressed with components of distance and angle or with by coding.

Moreover, the section which tends to be mismatched are the transfer ramp, the connection road and the entrance/exit of the interchange, where the roads branch at a small angle and run a distance, as described hereinbefore, and are known in advance. Therefore, the sections needing the transmission of the branch shape, the branch shape to be transmitted and the corresponding trunk shape may be defined in advance, and the defined branch may be inserted without fail in case the positional information of this route is to be transmitted.

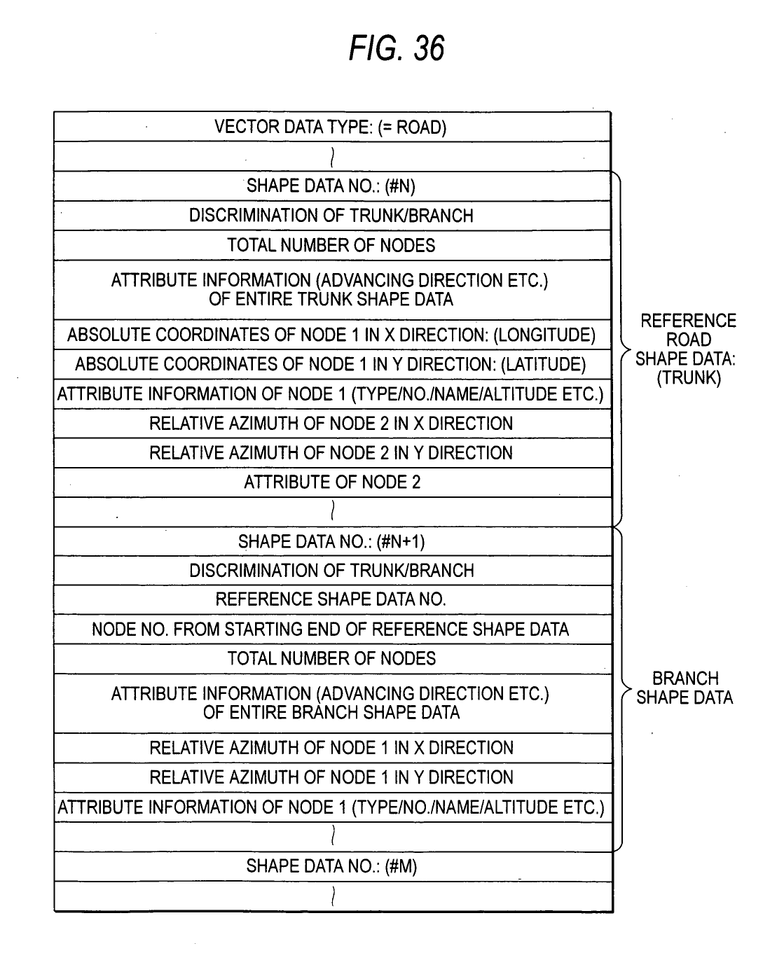

As shown in FIG. 36, the road attribute information of the branch shape data (i.e., the assistance shape data) may be added to the position codes.

At least one of the road type, the link type, the road number, the road name, the passing direction, the altitude, and the opening year of the road may be used as the road attribute information of the assistance shape data.

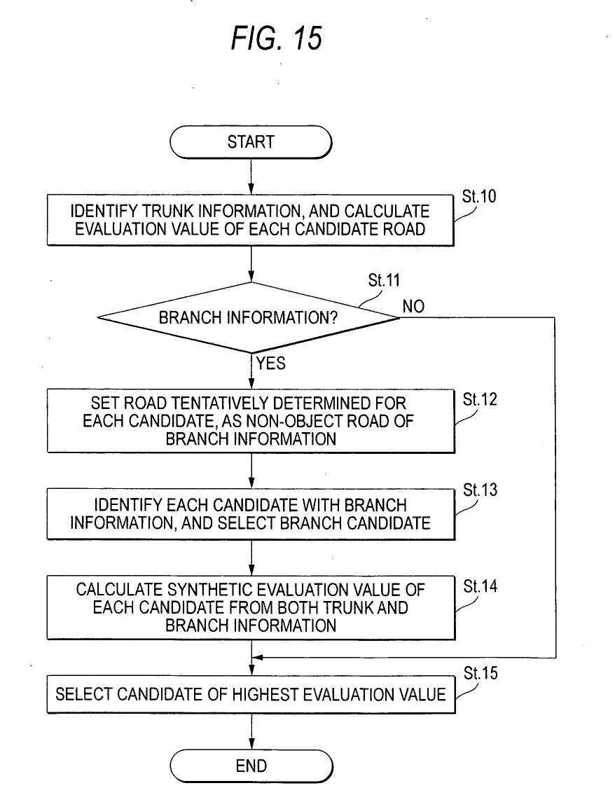

On the other hand, FIG. 15 is a flow chart showing the operation procedure of the information application device 40 (i.e., the decoding method for the positional information). The trunk shape data extraction unit 44 of the information application device 40 extracts the road shape data of the object road from the decoded shape data (FIG. 14), and the trunk candidate selection unit 47 selects the road candidate for the object road by map matching the road shape data with the map data of the digital map database B46, thereby to calculate the evaluation value of each candidate road (at Step 10). In case the branch shape data are included in the shape data decoded (that is, in case the answer of Step 11 is Yes), the branch shape data extraction unit 45 extracts those branch shape data. In order to determine the branch candidate (i.e., the assistance candidate) at the time that each candidate selected by the trunk candidate selection unit 47 is assumed to be the object road, the branch shape candidate selection unit 48 sets the candidate road as a non-object road of the branch candidate (or the assistance candidate) (at Step 12) and selects the branch candidate (or the assistance candidate) for each candidate (at Step 13) by the map matching using the branch shape data.

The evaluation value calculation/object road decision unit 49 calculates the synthetic evaluation value of each candidate from both the object road candidate and the branch candidate (i.e., the assistance candidate) (at Step 14), and selects the object road candidate of the highest evaluation value (at Step 15). In case the branch shape data are not included in the shape data (that is, in case the answer of Step 11 is No), the routine transfers to Step 14, at which the object road candidate of the highest evaluation value determined at Step 10 is selected.

To calculate the synthetic evaluation value of the object road candidate, the evaluation value calculation/object road decision unit 49 reproduces the original shapes of the object road and the branch with the road shape data and the branch shape data, and calculates the evaluation value indicating the similarity of the object road candidate and the branch candidate (or the assistance candidate) to the original shape, for example, in the following manner.

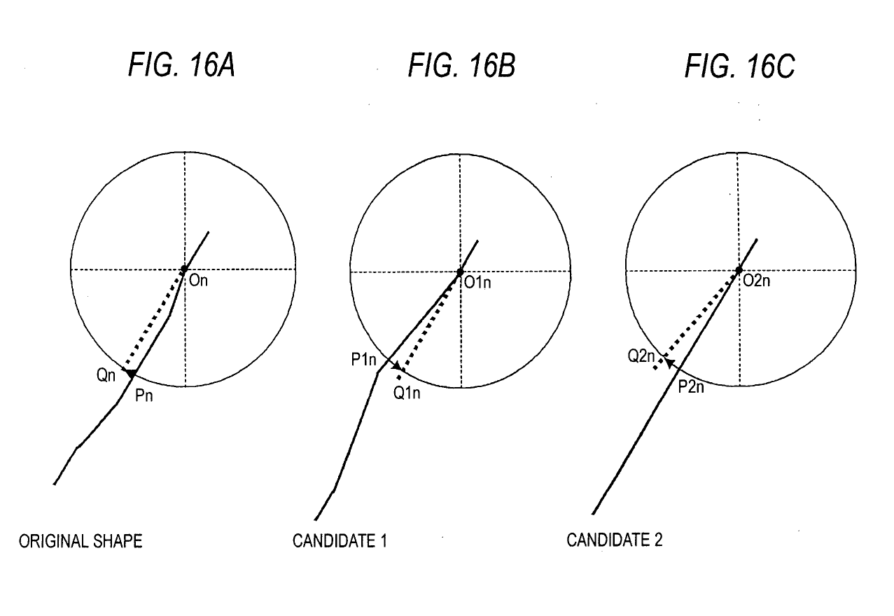

With reference to FIG. 16, the method for calculating the evaluation value indicating the similarity to the original shape (FIG. 8(a)), by way of an example of the road candidate (i.e., the object road candidate) of the object road and the branch candidate road (i.e., the branch candidate; the assistance candidate), as obtained in FIGS. 8(c) and 8(c).

(1) The point of intersection between a circle having a radius n around the branching point of a branch or a branch candidate (i.e., an assistance candidate) and an object road of an original shape is designated by Pn (Xn, Yn), and the point of intersection between that circle and an object road candidate k is designated by Pkn (Xkn, Ykn).

The intersection point between the circle of the radius n and the branch of the original shape is designated by Qn (Vn, Wn), and the intersection point between that circle and a branch candidate corresponding to the object road candidate k is designated by Qkn (Vkn, Wkn)

(2) A vector Δ n between Pn-Qn and a vector A kn between Pkn-Qkn are calculated by the following equations:
Δn=(ΔXn, ΔYn)=(Xn−Vn, Yn−Wn);
and
Δkn=(ΔXkn, ΔYkn)=(Xkn−Vkn, Ykn−Wkn).

That is, there are executed: the step of calculating a first vector between points on the object road and on the branch, the points being spaced at an equidistance from the intersection point between the object road and the branch in the original shape; and the step of calculating a second vector between points on the object road candidate and the branch candidate, the points being spaced at an equidistance from the intersection point between the object road candidate (i.e., the assistance candidate) and the branch candidate (i.e., the assistance candidate).
(3) The magnitude δ kn of the difference between the vectors Δ n and Δ kn is calculated by the following equation:

$$\begin{matrix}δ kn = \vert Δ n - Δ kn \vert \\ = \sqrt{} {( {( Δ Xn - Δ Xkn )}^{2} + ( Δ Yn - Δ Ykn ) )}^{2}\end{matrix} .$$

In short, the difference between the first vector and the second vector is calculated.

(4) As the value δkn is the smaller, the similarity to the original shape is the higher. The value δkn is calculated using several circles having different values of the radius n, and the value of Σ δkn is calculated as the evaluation value representing the similarity to the original shape (FIG. 8(a)). As this evaluation value is the smaller, the similarity to the original shape is the higher. Specifically, there are executed: the step of acquiring a plurality of first vectors by repeating the aforementioned first vector calculating step at every distances from the intersection point; the step of acquiring a plurality of second vectors by repeating the aforementioned second vector calculating step at every distances from the intersection point and in every combinations; and the step of calculating the differences between the plural first vectors and the plural second vectors in every combinations to select the object road candidate in the combination of the smallest difference finally as the object road.

The evaluation value calculation/object road decision unit 49 calculates the synthetic evaluation value of the object road candidate on the basis of the evaluation value representing the similarity to the original shape thus obtained and the evaluation value of the object road candidate determined at Step 10.

By selecting the candidate of the object road with those evaluations, even if road which branches at a small angle from the object road exists, the road can be prevented from being erroneously identified.

### Second Embodiment

The second embodiment of the invention is explained in connection with another method for determining the evaluation value representing the similarity of the object road candidate and the branch candidate (i.e., the assistance candidate, as omitted in the following) to the original shape.

In this method:

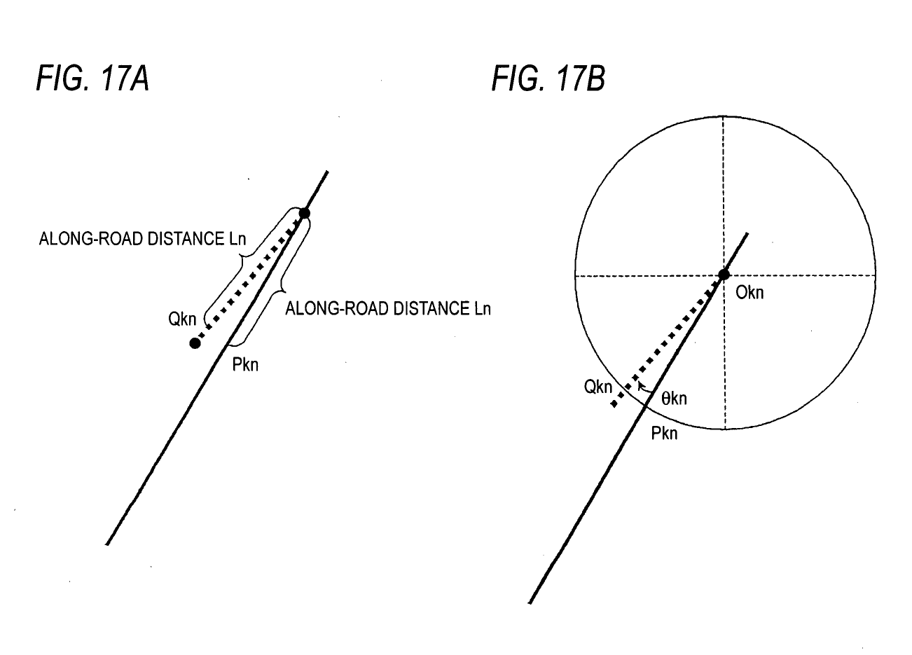

(1) As shown in FIG. 17(a), the coordinates of the point, which has proceeded by Ln from a branching point On of a branch along the object road of the original shape, are designated by Pn (Xn, Yn), and the coordinates of the point, which has proceeded by Ln along the branch of the original shape, are designates by Qn (Vn, Wn). Further, the coordinates of the point, which has proceeded by Ln along the object road candidate k, are designated by Pkn (Xkn, Ykn), and the coordinates of the point, which has proceeded by Ln along the branch candidate, are designated by Qkn (Vkn, Wkn);

(2) The angle θ n (with plus and minus signs) of Pn→On→Qn and the angle θ kn of Pkn→Okn→Qkn are calculated, as shown in FIG. 17(b). In short, the step of calculating the first angle, which is made between the original shape of the object road and the original shape of the branch, is executed; (3) The magnitude δ kn of the difference between the angle θ n and the angle θ kn is calculated by the following equation:
δkn=|θn−θkn|.

The step of calculating the second angle between the object road candidate and the branch candidate in every combinations of the object road candidate and the branch candidate is executed; and

(4) As the value δ kn is the smaller, the similarity to the original shape is the higher. Several values δ kn are calculated for different values Ln, and the value of Σ δ kn is calculated as the evaluation value representing the similarity to the original shape. As the evaluation value is the smaller, the similarity to the original shape is the higher. Specifically, the step of calculating the different between the first angle and the second angle in every combinations to select the object road candidate of the combination for the smallest difference finally as the object road is executed.

The evaluation value representing the similarity to the original shape can be obtained by that method.

### Third Embodiment

The third embodiment of the invention is described in connection with another method for calculating the synthetic evaluation value of the object road candidate.

In this method:

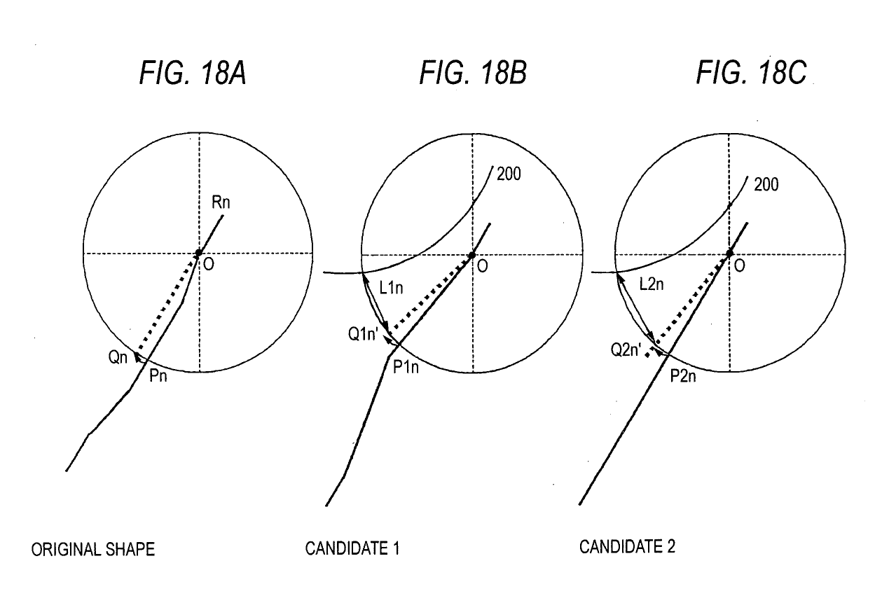

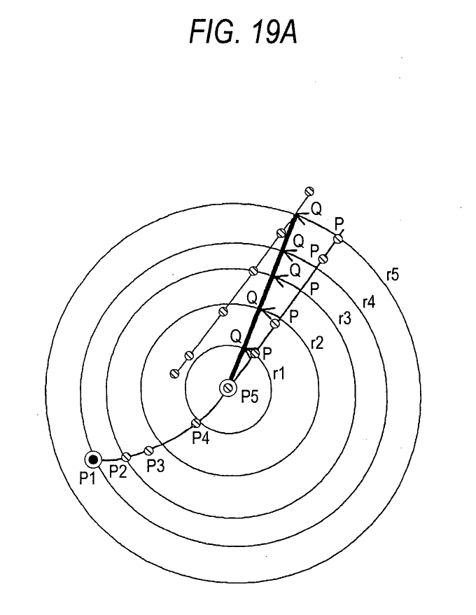

(1) As shown in FIG. 18(a), the intersection point Pn between a circle of a radius Rn having a branching point of a branch of an original shape at a center O, and the object road, and the intersection point Qn between the circle and the branch are calculated;

(2) The vector of Pn→Qn is calculated. This vector can be expressed either by the relative coordinates Δ Xn and Δ Yn, as shown in the first embodiment, or by the angle θ n between Pn→O→Qn and the Rn;

(3) As shown in FIGS. 18(b) and 18(c), the Qkn′ is set from the intersection point Pkn between the circle of the radius Rn having the branching point of the branch candidate at the center O and the object road candidate k by using the vector Pn→Qn;

(4) It is decided whether or not a road exists near the Qkn′ based on the road net excepting the object road candidate k, and the distance Lkn to the closest road 200 is calculated; and

(5) The value Σ Lkn is calculated as the evaluation value of the branch by executing the foregoing operations (1) to (4) for different Rn. The synthetic evaluation value of the object road candidates is calculated by adding the evaluation value of the branch and the evaluation value of the object road candidate (i.e., the evaluation value calculated at Step 10 of the flow chart of FIG. 15).

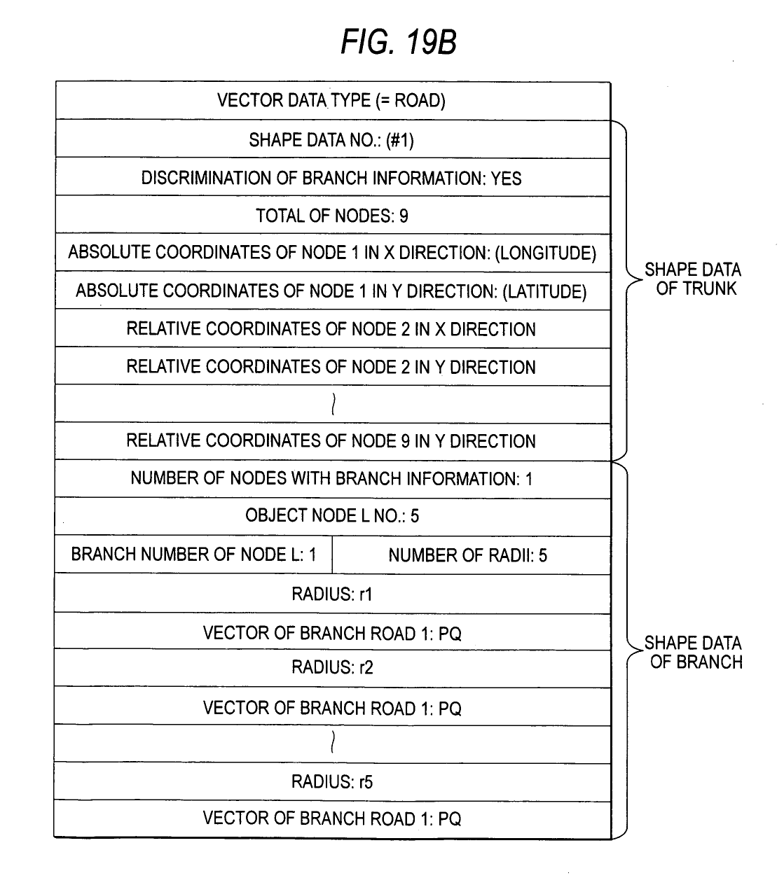

FIG. 19(b) shows the shape data to be sent from the transmission side to the reception side in the case of adopting the above method. In the shape data, as shown in FIG. 19(a), the vector of Pn→Qn corresponding to the plural radii Rn in the original shape is included as the branch shape data, so that the location identification on the reception side can be made efficient.

### Fourth Embodiment

The fourth embodiment of the invention is described as to another method for calculating the synthetic evaluation value of the object road candidate.

In this method:

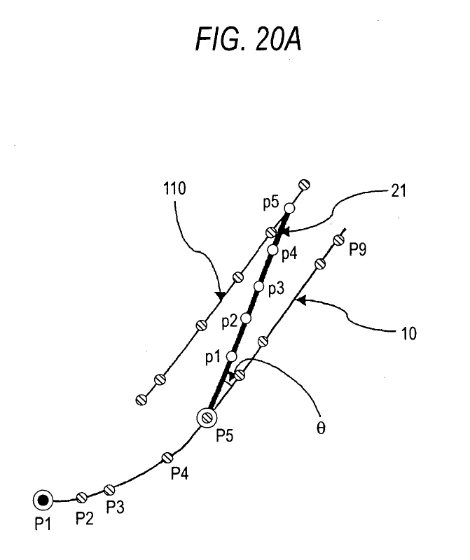

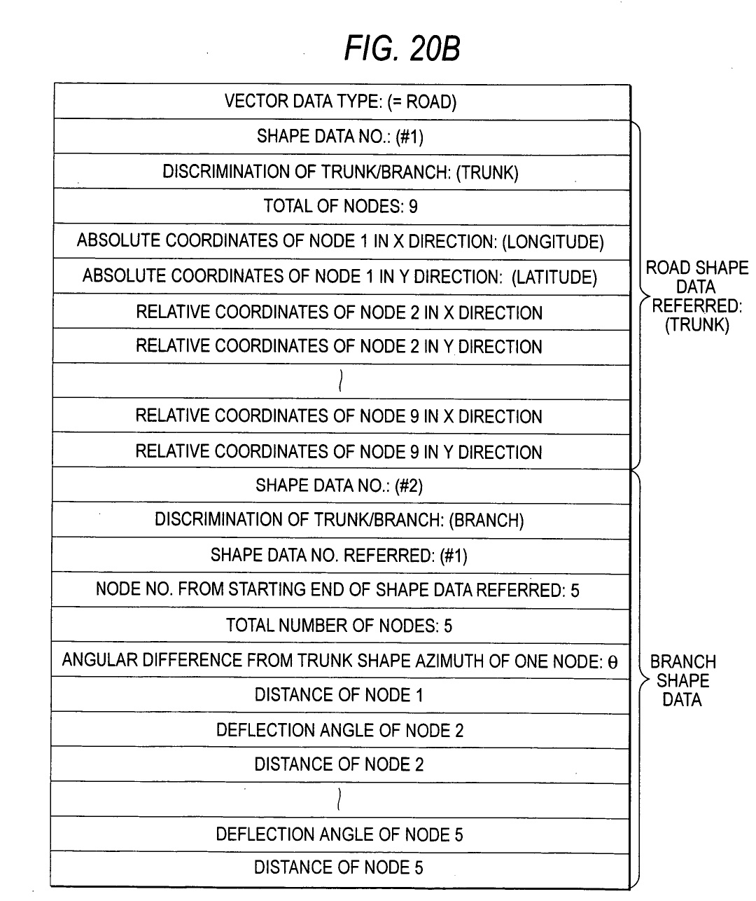

(1) On the transmission side, as shown in FIGS. 20(a) and 20(b), the node P1 of the branch 21 is represented by an angular difference θ from the object road 10, and the distance from the branching point P5 (i.e., the starting end of the branch 21), and the subsequent nodes p2, p3, p4 and p5 are represented by the deflection angle from the adjoining node and by the distance;

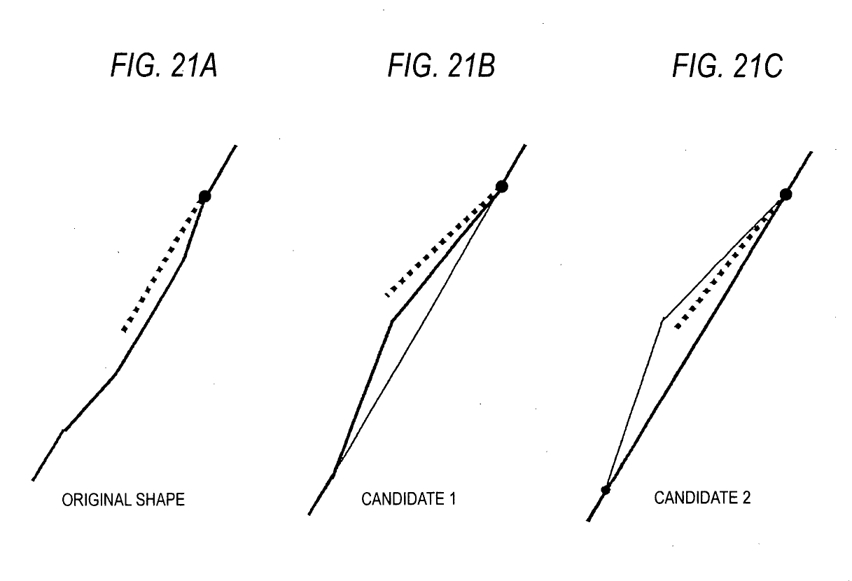

(2) The reception side having received the shape data (of FIG. 20(b)) performs location identifications using the road shape data, and selects the road for the candidate of the object road thereby to calculate the evaluation value of each candidate road. The branch shape, which is located at a position relative to each object road candidate is reproduced from the branch shape data included in the shape data. FIG. 21(a) shows the object road and the branch of the original shape; FIG. 21(b) shows the branch shape (in a dotted line) which is reproduced at a position relative to the object road candidate 1 (in a thick line); and FIG. 21(c) shows the branch shape (in a dotted line) which is reproduced at a position relative to the object road candidate 2 (in a thick line);

(3) The road of the object road candidate is set to a non-object road of the branch candidate and the location identification is conducted for the branch, and the branch candidate is selected to calculate its evaluation value. In FIGS. 21(b) and 21(c), roads indicated by thin lines are selected as individual branch candidates. Therefore, the evaluation result of the branch candidate of FIG. 21(c) is better than that of the branch candidate of FIG. 21(b); and

(4) The object road candidate of the better evaluation result is selected by adding the evaluation value of the branch candidate to the evaluation value of the object road candidate. As a result, the object road candidate 2 (FIG. 21(c)) is selected.

In case this method is adopted, since the branch shape data included in the shape data (FIG. 20(b)) are represented by the angle and the distance, the amount of data is reduced.

### Fifth Embodiment

The fifth embodiment of the invention is described as to a method for compressing the amount of shape data to be transmitted.

In the compression of the amount of the shape data, as described in Patent Publication 3, an equidistance resampling is done for the object road and the branch, and the position data of the individual sampling points other than the starting end are represented by either a deflection angle θ j from the adjoining sampling point or a differential value Δ θ j of statistical predicted value and are encoded to a variable length.

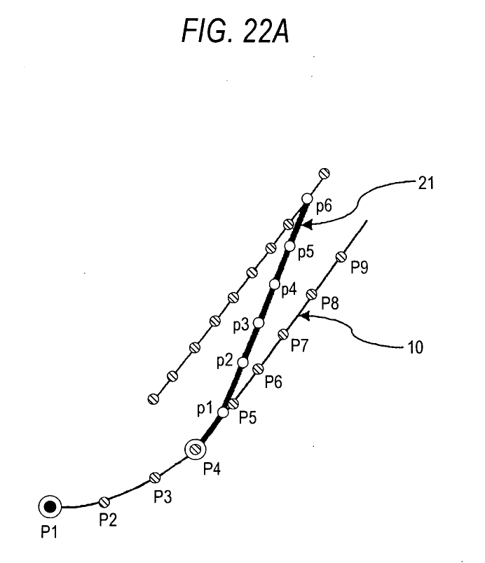

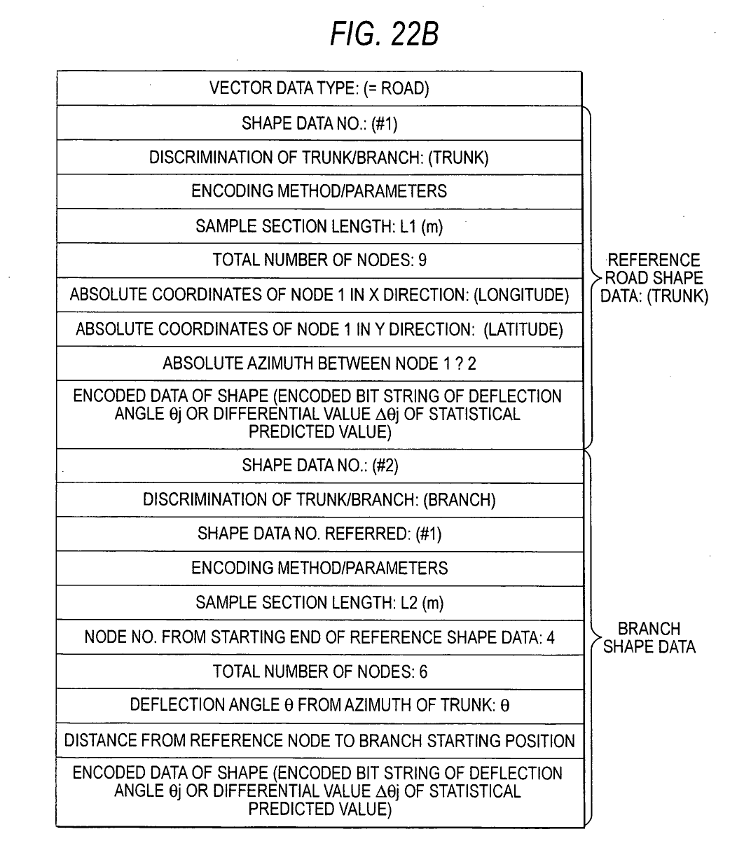

In FIG. 22(a), there are shown the sampling points P1, P2, - - - , and P9 set at the object road 10 by the equidistance resampling, and the sampling points p1, p2, - - - , and p6 set at the branch 21 by the equidistance resampling. The point p1 is the point where the branch 21 branches from the object road 10, and does not always coincide with the sampling point of the object road 10. In order to correlate the branch 21 to the sampling point of the object road 10, therefore, the sampling point P4 on the object road 10 upstream of the point p1 closest to the point p1 is defined as the starting end (i.e., the starting reference point) of the branch 21.

FIG. 22(b) tabulates the shape data including the compressed/encoded road shape data of the object road 10 and the compressed/encoded branch shape data of the branch 21, the starting end of which is redefined. In these branch shape data, the number, as counted from the point P1 of the point P4 defined as the starting end of the branch 21 is described as the “Node No. from Starting End of Reference Shape Data”, and the distance from the Point p4 to the point p1 is described as the “Distance from Reference Node to Branch Starting Position”.

Thus, by compressing the amount of the shape data, the load at time of the data transfer is reduced.

Accordingly, in the digital map positional information transmission method of the invention, the transmission side transmits the shape of the object road by adding to it the road to intersect or branch as the branch shape, and the reception side specifies the object road with reference to the branch shape. Thus, the matching error on the reception side can be prevented.

The error in the location identification, as might otherwise occur in case the road representation forms (i.e., the single-/double-lines) of the digital map held on the transmission side and the reception side are different, cannot be prevented merely by adding the information such as the link number or the link angle of the connection links to the road shape data of the object road. However, the positional information transmission method of the invention for adding the branch shape as the reference information can avoid the error in the location identification, even in case the road representation forms of the digital map on the transmission side and the reception side are different.

On the reception side, the object road 10 and the parallel road 110 of FIG. 13, for example, can be discriminated by referring to the branch shape, thereby to avoid the error of the location identification to the parallel road.

### Sixth Embodiment

The sixth embodiment of the invention is described as to a method for specifying the branching position of a branch.

In case the transmission side transmits the road shape data of the object road and the branch shape data of the branch, the reception side can eliminate the deviation in the length direction of the object road in the location identification with reference to the branching position of the branch. Therefore, the branching position of the branch is employed as the reference point of the traffic information expression, and the delay position, the accident position and so on are expressed by the distance from the reference point, so that the traffic information can be precisely transmitted.

In case, however, digital maps of different scales are used in the transmission side and the reception side, it is not easy for the reception side to specify the branching position of the branch from the shape data of the object road and the branch received.

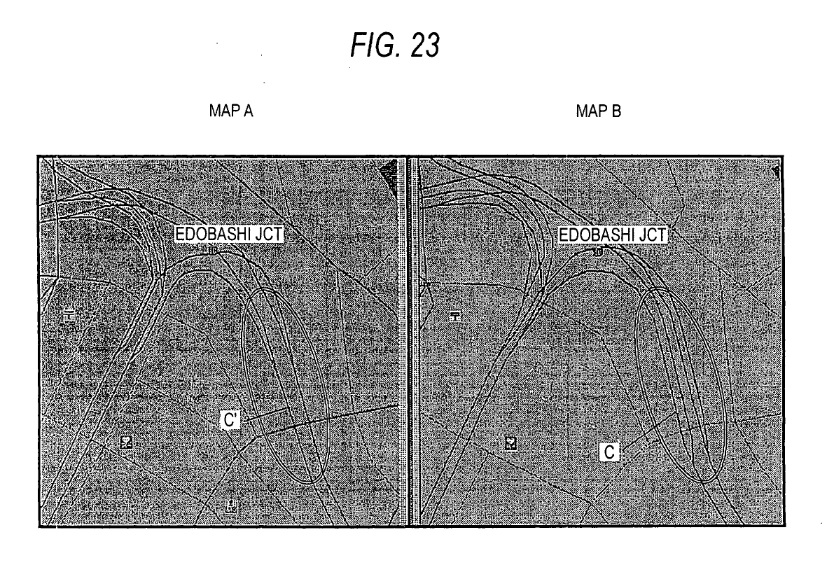

FIG. 23 exemplifies a Map A of a scale of 1/25,000 and a map B of a scale of 1/2,500 representing the shapes of the trunk and the connection roads (i.e., the junction lanes) of the same area. In the map (i.e., the Map B) of the smaller diminishing scale, the junction (as enclosed by an ellipse) of the connection road is represented more finely because of a higher precision so that it has longer connection roads than those of the map (i.e., the Map A) having a larger diminishing scale. Thus, the branching position of the road branching at a smaller angle is considerably different in dependence upon the precision of the map.

In this case, if the transmission side transmits the shape data of the connection roads represented in the Map B whereas the reception side specifies the position with the Map A, then a part of the connection roads are erroneously identified as the trunk. If, therefore, an event of the closed road (or the traffic accident) occurs so that the transmission side transmits the shape data of the connection roads and the information on the distance from the branching position of the connection roads to the event position, the reception sides misjudges that the event has occurred at the point C′ of the trunk. The “event (or information)” means the object of information to be transmitted, such as the delay, the accident or the POI (Point Of Interest).

This embodiment is described as to the location identification method for specifying the branching position of a branch correctly on the digital map so as to avoid such misjudgment.

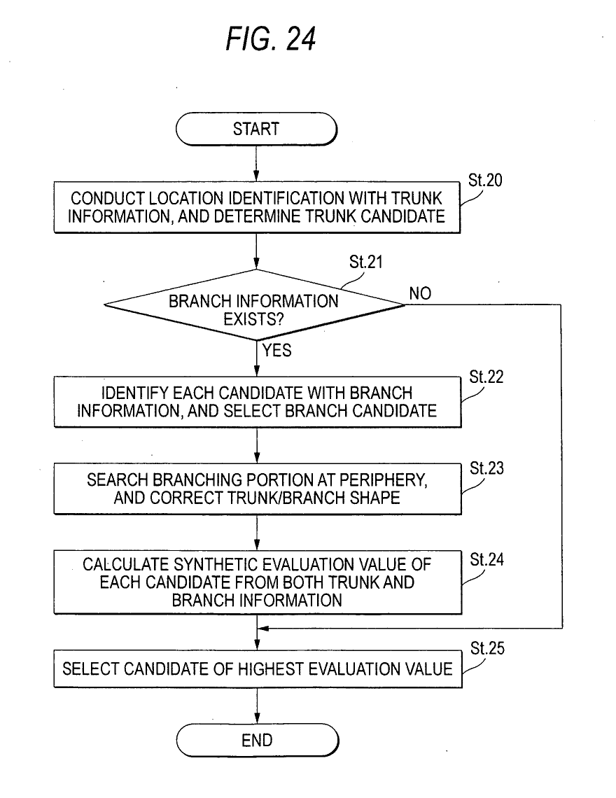

FIG. 24 shows the location identification procedure of this case. The reception side having received the shape data (FIG. 14) containing the road shape data of the trunk and the branch shape data of the branch conduct the location identification on the road shape data of the trunk to correspond to its own digital map data, and selects the candidate road for the trunk to calculate the evaluation value of each candidate road (at Step 20). In case the received information contains the branch shape data (that is, in case the answer of Step 21 is Yes), the location identification is made using the branch shape data to select the branch candidate for each candidate road (at Step 22).

On the own digital map, the branching portion is searched from the periphery of the point, which is the “Node No. from Starting End of Shape Data Referred” of the branching point (FIG. 14) of the branch, and the trunk shape and the branch shape are so corrected that the branch may branch at that branching portion from the trunk (at Step 23).

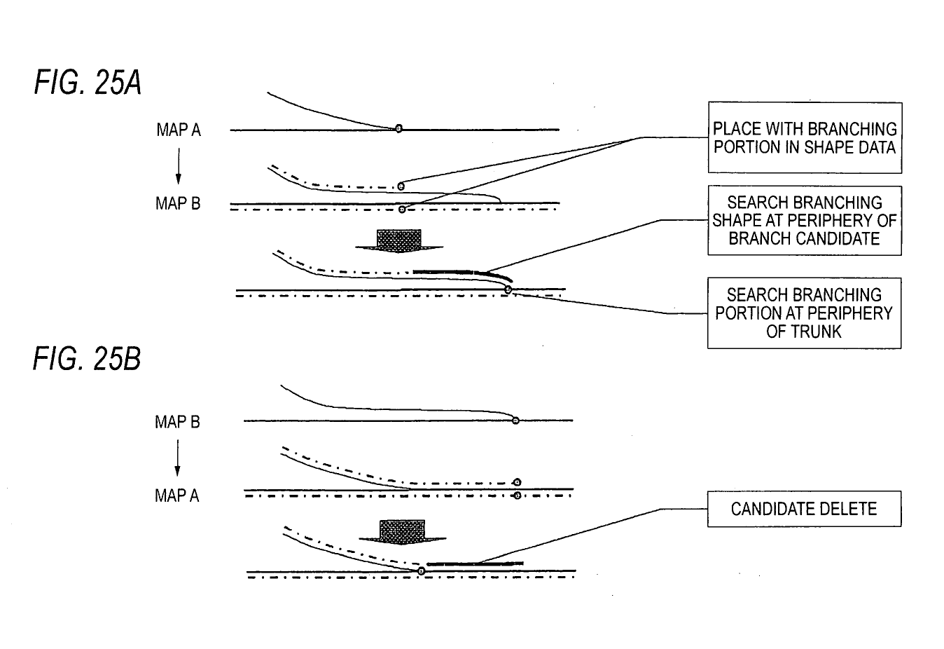

FIG. 25 schematically shows this correcting operation. FIG. 25(a) shows the case, in which the shape data are transmitted from the transmission side having the Map A to the reception side having the Map B. The reception side selects the trunk candidate and the branch candidate from its own Map B and sets the point corresponding to the branching point in the Map A, on those candidates thereby to search the branching portion from the periphery of that point. The reception side searches the branching shape (i.e., a thick line portion) leading to the branching portion on the trunk candidate, from the periphery of the corresponding point of the branch candidate thereby to add the branching shape to the branch candidate.

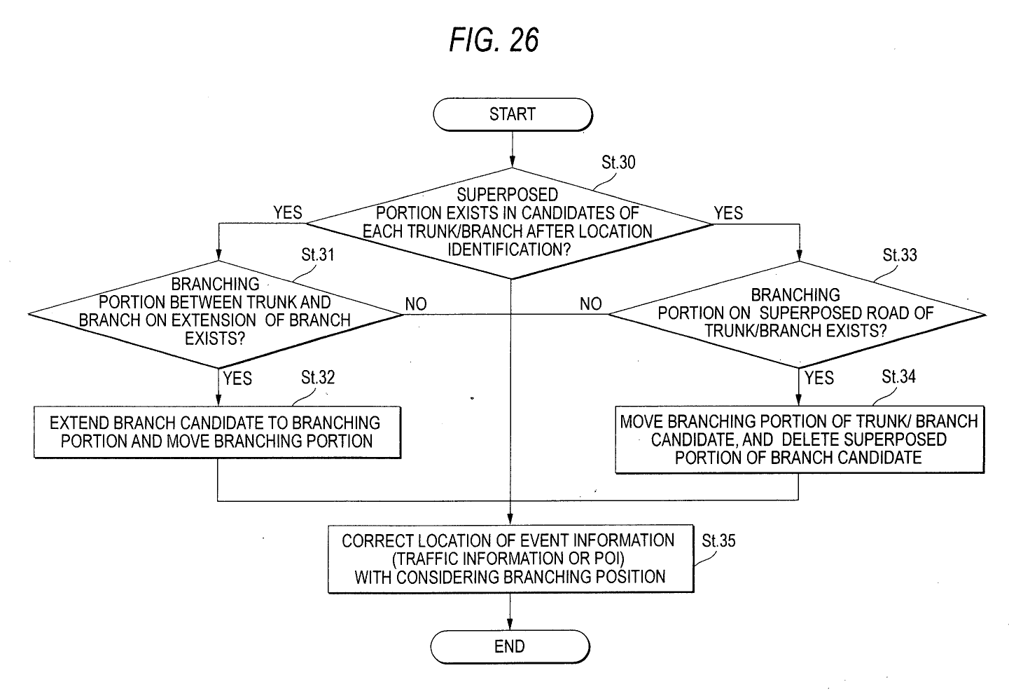

FIG. 25(b) shows the case, in which the shape data are transmitted from the transmission side having the Map B to the reception side having the Map A. The reception side selects the trunk candidate and the branch candidate from its own Map A, and sets the point corresponding to the branching point on the Map B thereby to search the branching portion from the periphery of that point on the trunk candidate. In case the periphery of the corresponding point of the branch candidate is searched to find that the branching portion is positioned on the branch candidate, the branch candidate shape (i.e., a thick line portion) is deleted from the corresponding point to the branching portion. In short, there are executed: the step of searching the branching point, where the object road candidate and the branch candidate or its extension branch on the digital map; and the step of correcting the shape of the branch candidate into a shape to branch at the branching point from the object road candidate. FIG. 26 is a flow chart showing the procedure of this correcting operation.

It is decided (at Step 30) whether or not a superposed portion exists between the trunk candidate and the branch candidate. In the case of no superposed portion (i.e., in the case of FIG. 25(a)), next it is decided (at Step 31) whether or not the trunk/branch branching portion exists on the extension of the branch candidate. In the case of the trunk/branch branching portion existing, the branch candidate is extended to the branching portion thereby to move the branching portion (at Step 32). In case the superposed portion exists between the trunk candidate and the branch candidate (i.e., in the case of FIG. 25(b)), it is decided (at Step 33) whether or not the branching portion exists on the superposed road of the trunk/branch. In the case of the branching portion existing, the branching portion is moved to the branching portion thereby to delete the superposed portion of the branch candidate (at Step 34).

After the corrections of the trunk/branch shapes, the synthetic evaluation value of each trunk candidate is calculated from both the trunk candidate and the branch candidate (at Step 24), and the trunk candidate of the highest evaluation value is selected (at Step 25). Here, in case the branch shape data are not included in the shape data (that is, in case the answer of Step 21 is No), the routine transfers to Step 25, at which the trunk candidate of the highest evaluation value determined at Step 20 is selected.

The synthetic evaluation value of the trunk candidate is calculated on the basis of:

(1) the shape similarity and the spacing distance between the trunk shape and the trunk candidate;

(2) the shape similarity and the spacing distance between the branch shape and the branch candidate;

(3) the presence/absence of the branching portion, and the positional displacement of the branching portion, if any; and

(4) the relative shape similarity between the trunk/branch around the branching portion.

The reception side corrects the event information (e.g., the traffic information or the POI) with taking into account the branching position (i.e., the corrected branching position of the case, in which the branching position is corrected at Step 32 and at Step 33). In short, the position of the aforementioned “object” is related to the object road data or the assistance shape data so that the position of that “object” is corrected.

By these operations on the reception side, the branching position to be transmitted by the transmission side is correctly specified on the digital map on the reception side. Therefore, the transmission side can designate the connection road with the branching position or can transmit the event position using the branching position for the reference point (or the marker position).

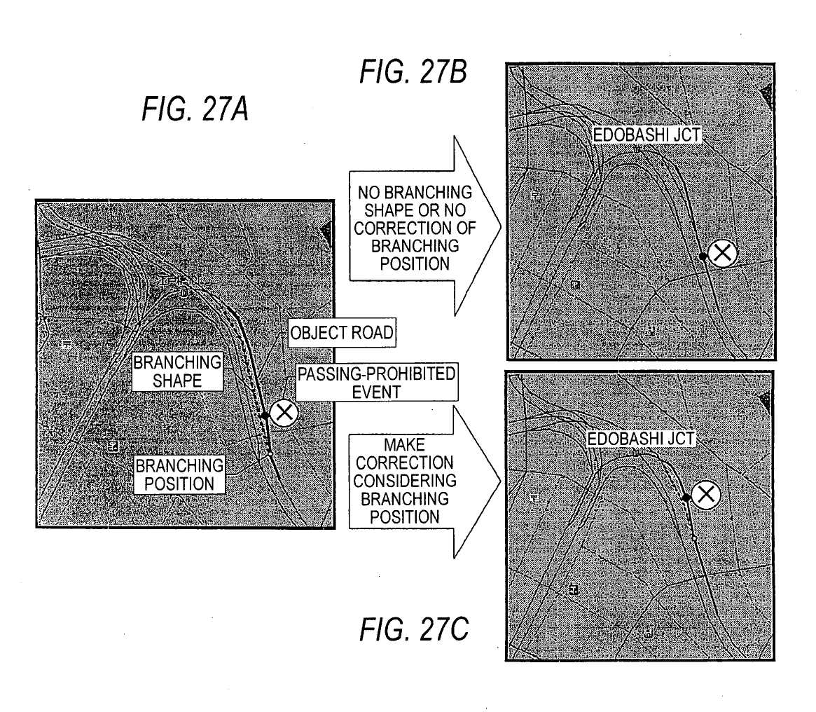

FIG. 27 schematically shows the case (FIG. 17(a)), in which the transmission side using a high precision map transmits the event information (e.g., the closed road) of the object road together with the object road shape and the branching shape, the case (FIG. 27(b)), in which the reception side using a poor precision map specifies the event position without correcting the branching position, and the case (FIG. 27(c)), in which the reception side corrects the branching position by the method of this embodiment and specifies the event position with taking the branching position into account. In the case of FIG. 27(b), an error on the latitude and longitude is small from that of the transmission side at the closed road position, but the “closed road” is displayed at a mistaken position on the road network. In the case of FIG. 27(c), in which the branching position is corrected by the method of this embodiment, on the other hand, the “closed road” is displayed at the correct position on the road network. In other words, the position of the event information relating to the object road shape data and the branch shape data are corrected with reference to the shape of the branch corrected candidate.

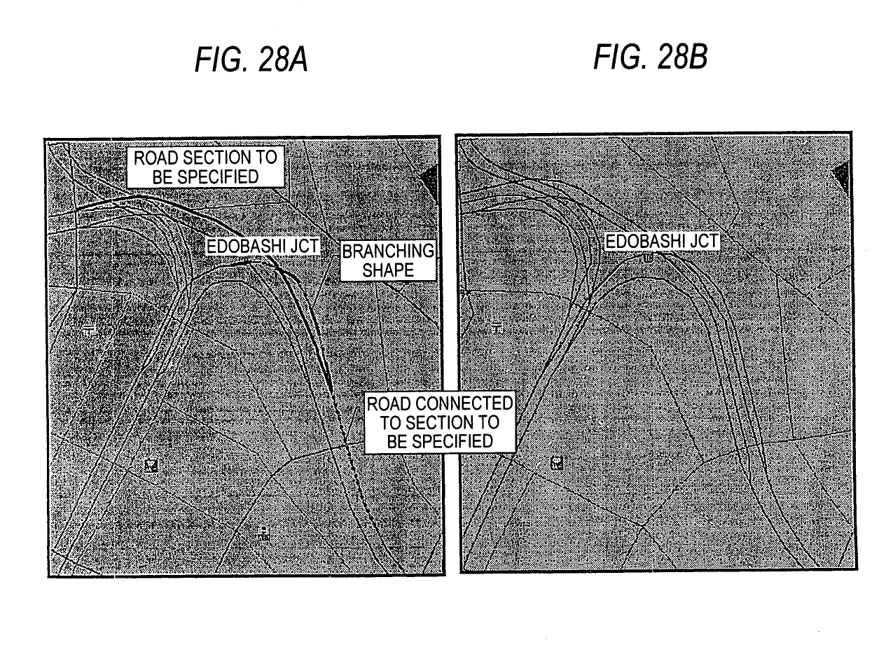

Since the reception side searches the periphery of the branching position transmitted from the transmission side and specifies the branching position of the branch on its own map, as described above, the transmission side preferably transmits not only the shape data of the trunk section (in a thick line) and the branch section (in a single dotted line) to be transmitted but also the shape data of the road portion (in a single-dotted line) to be connected to this section as shown in FIG. 28(a). The length to the road to be added is qualitatively the map error difference between the map (FIG. 28(a)) on the transmission side and the map (FIG. 28(b)) on the reception side. In case the transmission side uses a map of 1/25,000 whereas the reception side uses a map of 1/2,500, the map error different is about 100 m, but it is desired to add the road shape of about 100 to 200 m for an allowance.

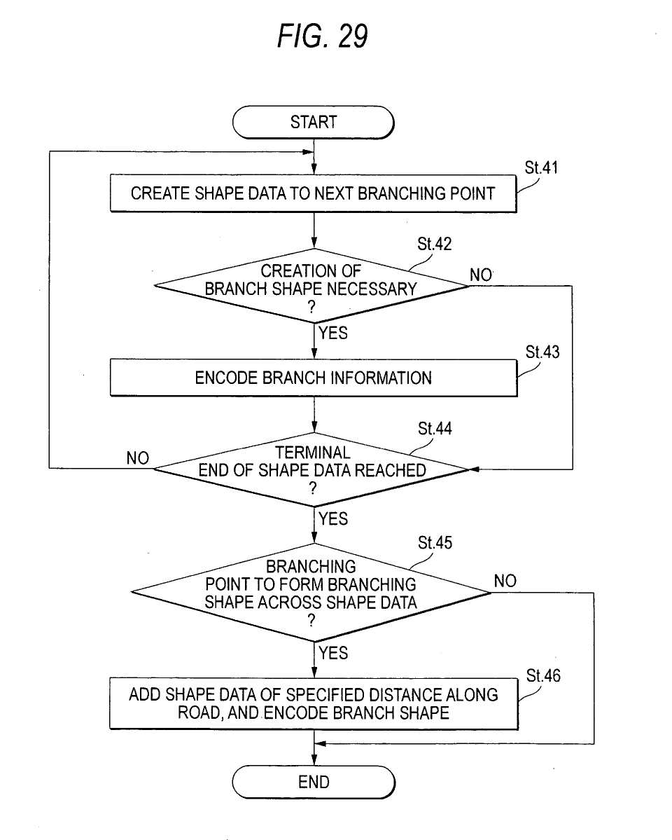

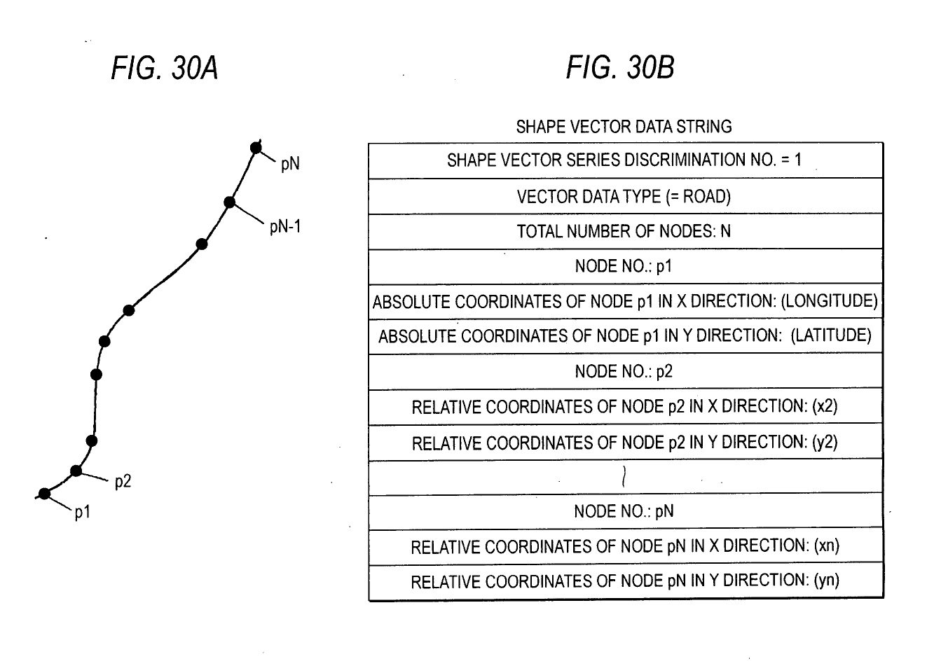

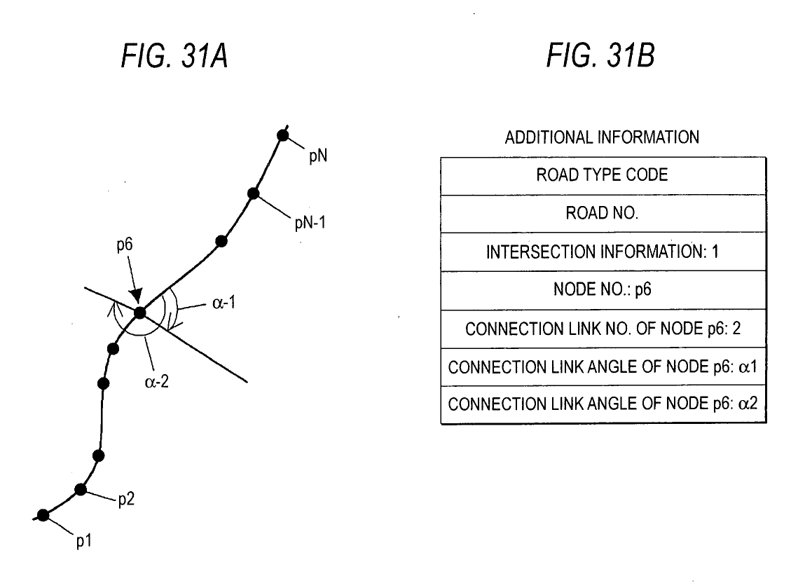

The flow chart of FIG. 29 shows the procedure for the transmission side to create the transmission shape data while considering the addition of the road shape.

The road shape data are created from the starting point of the truck section to be transmitted to the next branching point (at Step 41). It is decided (at Step 42) whether or not it is necessary to create the branch shape of the branch from that branching point. The branch shape data, if necessary, are created (at Step 3). If not, the branch shape data are not created. If the branching point is not the terminal of the trunk section (at Step 44), the routine returns to Step 41 and the road shape data to the next branching point is created, and the operations of Step 41 to Step 43 are repeated until the terminal end of the trunk section is reached. The operations until here are identical to those of FIG. 12.

When the terminal end of the trunk section is reached, it is decided (at Step 45) whether or not the branching point at which the branch shape is to be created exists before or after the created road shape data (i.e., at the starting end or the terminal end of the trunk section). If this answer is Yes, the road shape data of the specified distance along the trunk is added to create the branch shape data (at Step 46).

By these operations, the transmission side creates and transmits the road shape data of the trunk and the branch shape data of the branch so that the reception side can specify the trunk section and the branch section highly precisely even in case the reception side uses a digital map of a diminishing scale different from that of the transmission side.

Thus, it is highly effective for the transmission side and the reception side to transmit not only the road shape of the object road but also the branch shape. Therefore, the reception side may transmit the branch shape widely irrespective of the angle of the branch or the intersection. In this case, the reception decides whether or not the branch shape is to be referred to (e.g., not referred to when the evaluation value exhibits an extremely excellent value) on the basis of the evaluation value of the object road candidate determined either at Step 10 of the flow chart of FIG. 15 or at Step 20 of the flow chart of FIG. 24. Then, the branch shape data can be utilized without being followed by a heavy load.

### Seventh Embodiment

The seventh embodiment of the invention is described as to a correction method of the case, in which the road section absent from the map data on the reception side is included in the position codes from the transmission side.

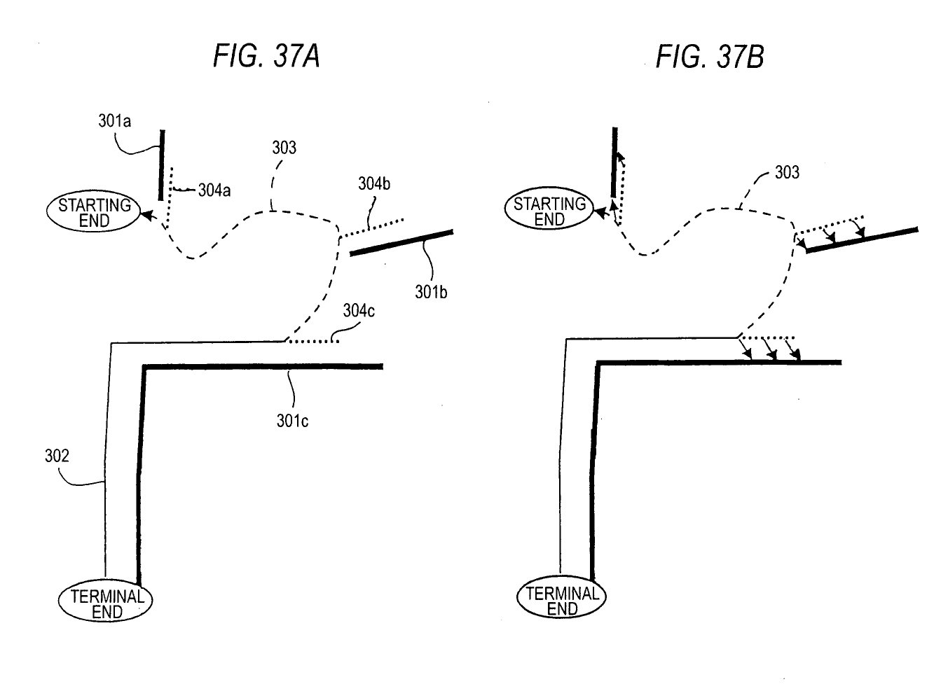

In the map data on the reception side of FIG. 37(a), existing road networks 301a, 301b and 301c are present. On the other hand, the transmission side transmits connection roads 304a, 304b and 304c which correspond to the roads 301a, 301b and 301c on the reception side and are to be specified at locations thereof.

In the position codes from the transmission side, there is not only an object road (or object road data) 302 as the object road data but also a road 303 connected to that road 302, which forms part of the object road data.

Since the section 303 is a new road, however, the map data corresponding to the section 303 does not exist on the reception side. Even if, therefore, the section 303 is included in the position codes coming from the transmission side, it is impossible to find the road which corresponds to the section 303 and to the object road.

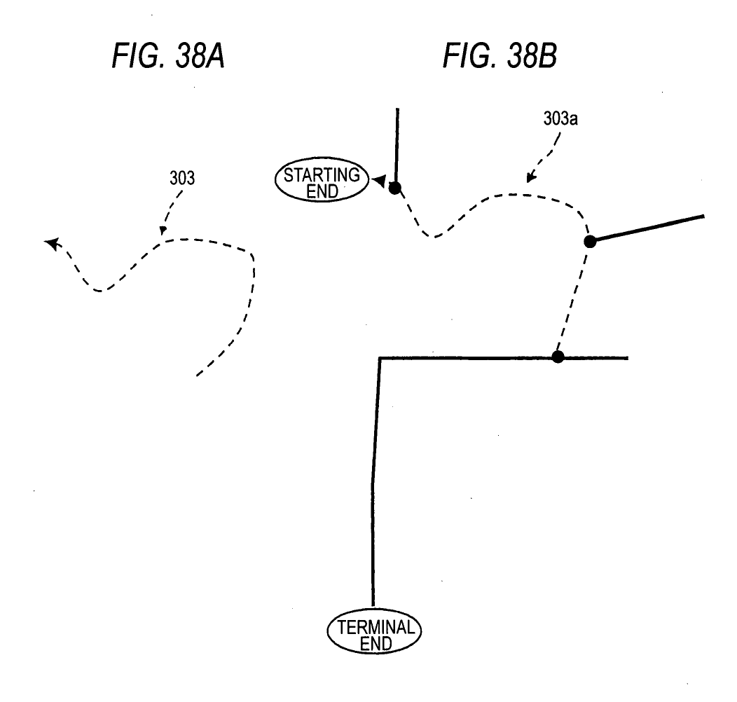

In this case, the section (or the virtual route) 303 is created assuming that the section 303 is present on the reception side map data. For this creation method, a variety of existing techniques (e.g., the method for encoding and decoding an object in a traffic road net, as disclosed in WO01/018769) can be used. In this embodiment, the reception connection roads 304a, 304b and 304c are used as the assistance shape data for the creations. In case the connection roads 304a, 304b and 304c are identified to correspond to the roads 301a, 301b and 301c on the reception side, respectively, as shown in FIG. 37(b), corrections are made to move the connection roads 304a, 304b and 304c schematically in the direction of arrow. According to these corrections, the shape of the section 303 is corrected from FIG. 38(a) to a shape 303a of FIG. 38(b) and is displayed on the map of the reception side. Thus, the position codes are precisely decoded. Specifically, when a new route absent from the map on the reception side is to be identified, the precision of reproduction of the shape of the new route or a portion of the object road can be enhanced by using the assistance shape data.

### Eighth Embodiment

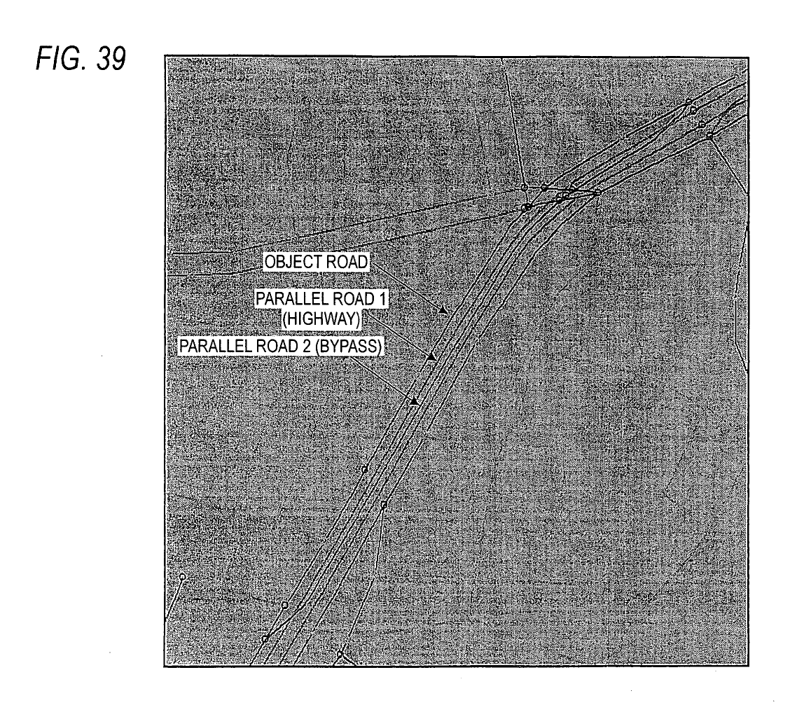

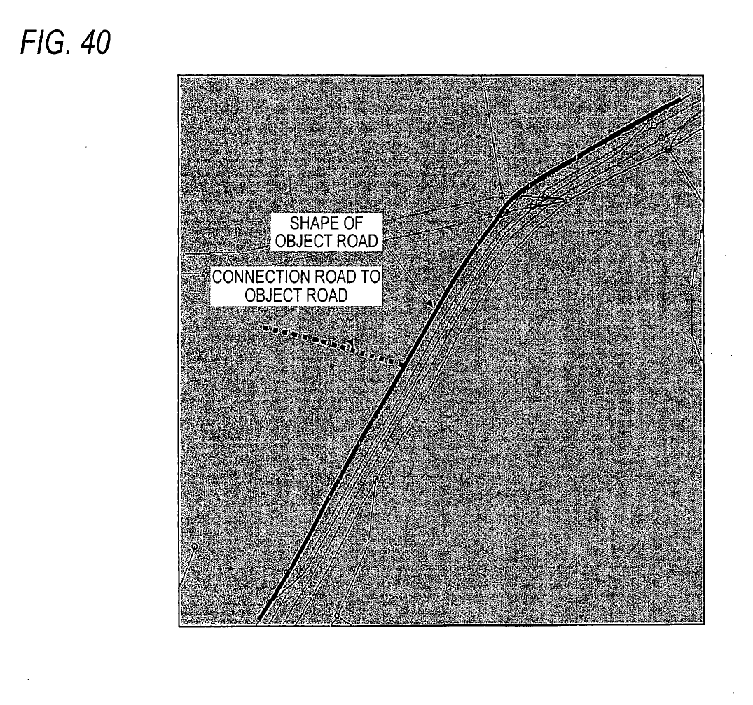

In this embodiment, there is described a specific example of the location identification of the case in which there is another road parallel and similar to the periphery of the object road. In case a parallel road (e.g., a highway) 1 and a parallel road (e.g., a bypass) 2 are present adjacent to the object road, as shown in FIG. 39, it seems that the object road may be misunderstood as the parallel road 1 or the parallel road 2. In this embodiment, therefore, the connection road to be connected to the object road is incorporated as the assistance shape data into the position codes, as shown in FIG. 40. Specifically, the assistance shape data including at least one of the connection position, the shape and the attribute of that connection road are transmitted together with the object road shape data to the transmission side.

The connection road of FIG. 40 is not connected to the parallel road 1 or the parallel road 2. It is accordingly possible to reliably discriminate the parallel road 1 or the parallel road 2 from the object road and to specify the object road. It is, therefore, possible to prevent the parallel road 1 or the parallel road 2 from being misjudged as the object road.

### Ninth Embodiment

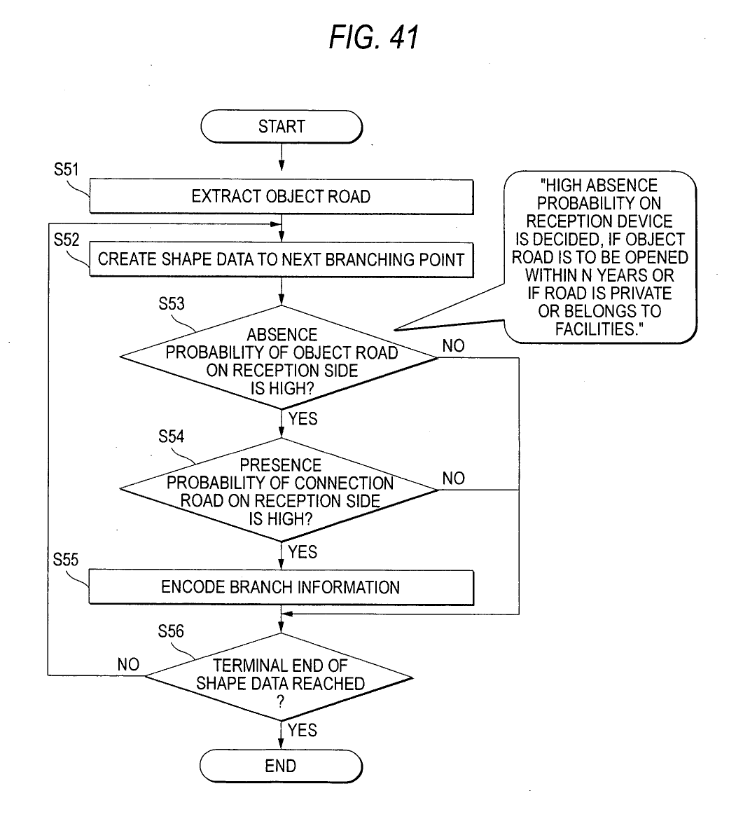

This embodiment is described as to the operations of the case in which the object road on the decode side includes such a section as may be highly possibly absent from the transmission destination of the position codes, i.e., from the map data on the reception side, as shown in FIG. 37. In case it is highly probable or possible that the object road is absent from the reception side, as at Step 53 of FIG. 41, and the connection road to that object road is present on the reception side, as at Step 54, the encoder side creates the assistance shape data (or the branch shape data) based on the connection road (at Step 55). Here can be used various grounds for deciding the possibility at Step 53. These deciding grounds can be the opening year of the road or the type (e.g., a private road or a road belonging to facilities) of the road. With this, the operations of the steps of FIG. 37 and FIG. 38 can be smoothly performed.

The program for causing the information transmission device 30 to provide the positional information for the digital map is also contained in the scope of the invention. This program causes the information providing device to execute the procedure for extracting the object road shape data corresponding to the transmission object road, the procedure for extracting the branch shape data corresponding to the branch intersecting with or branching from the object road, from the digital map database, and the procedure for transmitting the object road shape data and the branch shape data extracted, to the outside. There is also provided a program product having that program recorded on a recording medium. The recording medium is not limited in kind but can be exemplified by all kinds of media such as the CD, the MD or the hard disk. The program product having a specific program recorded in a predetermined medium can be read out by a predetermined computer or hardware.

Moreover, the program for causing the information application device 40 to receive and utilize the positional information for the digital map is also contained in the range of the invention. This program causes the information application device to execute the procedure for accepting the object road shape data of the object road and the branch shape data corresponding to the branch intersecting with or branching from the object road, from the outside, the procedure for selecting the object road candidate from the digital map database with reference to the object road shape data, the procedure for selecting the branch candidate from the digital map database with reference to the branch shape data, and the procedure for finally selecting the object road candidate to become the object road, with reference to the object road candidate and the branch candidate. There is also provided a program product having that program recorded on a recording medium.

The aforementioned program or program product may be directly incorporated into the information transmission device 30 or the information application device 40 or may be incorporated into another medium drive device so as to control the information transmission device 30 and the information application device 40 indirectly. Of course, the program or the program product may also be executed by the computer so that the computer may control the information transmission device 30 and the information application device 40.

In the foregoing embodiments, in the decode on the reception side, the object road is identified by using both the object road shape data and the assistance shape data in the position codes. In case, however, the location identification seems to have been hardly mistaken (e.g., in case the branch branches at a large angle from the object road or in case the branch is not parallel to the object road from the branching point), it is not always necessary to perform the decode operation. After the position codes containing such two kinds of data were received, for example, the object road shape data and the assistance shape data are separated. By referring to only the object road shape data or by extracting only the object road shape data, the object road may be specified on the digital map. As a result, it is possible to reduce the processing load on the reception side.

Although the invention has been described in connection with the specific embodiments, it is apparent to those skilled in the art that the invention could be modified or corrected in various manners without departing from the scope and scope of the invention.

The present application for patent is based on Japanese Patent Application (No. 2003-285807) filed on Aug. 4, 2003 and Japanese Patent Application (No. 2004-028040) filed on Feb. 4, 2004, the contents of which are incorporated herein as reference.

### INDUSTRIAL APPLICABILITY

The positional information transmission method, and the program, the program product, the system and the device for executing that method can be widely applied to the case, in which the road position on the digital map such as the object road of the traffic information, the traveled path of the probe car or the route information to the destination is to be transmitted; so that the transmission of a precise road position can be realized.

1. An positional information transmission method of transmitting positional information from a transmission side to a reception side provided with a digital map, comprising the steps of:
forming, on the transmission side, position codes based on object road shape data of a transmission object road and assistance shape data of a road to be connected to the object road; and
transmitting the position codes from the transmission side to the reception side.

2. A positional information transmission method according to claim 1, further comprising:
a step of adding the object road shape data and connection positional information of the assistance shape data to the position codes.

3. A positional information transmission method according to claim 2,
wherein the connection positional information is expressed with a number of points constituting the object road shape data.

4. A positional information transmission method according to claim 1, further comprising:
the step of adding attribute information for discriminating the object road shape data and the assistance shape data to at least one of the object road shape data and the assistance shape data.

5. A positional information transmission method according to claim 1, further comprising:
the step of adding road attribute information of the assistance shape data to the position codes.

6. A positional information transmission method according to claim 1,
wherein at least one of a road type, a link type, a road number, a road name, a passing direction, an altitude, a road opening year is used as road attribute information of the assistance shape data.

7. A positional information decoding method of decoding positional information of a digital map, comprising the steps of:
receiving position codes including object road shape data of a transmission object road and assistance shape data of a road to be connected to the object road; and
specifying the object road on the digital map with reference to the object road shape data and the assistance shape data.

8. A positional information decoding method according to claim 7,
wherein the step of specifying the object road on the digital map includes steps of:
deciding a similarity of shapes of the object road shape data and the assistance shape data, to an object road candidate for the object road shape data and an assistance candidate for the assistance shape data; and
finally selecting the object road candidate for the object road on the basis of the result of decision.

9. A positional information decoding method according to claim 8,
wherein the step of specifying the object road on the digital map includes steps of:
searching a point corresponding to a connection position between the object road shape data and the assistance shape data, on the digital map; and
correcting a position of an object correlated to one of the object road shape data and the assistance shape data, with reference to the position of the point.

10. A positional information decoding method according to claim 7,
wherein the step of specifying the object road on the digital map includes the step of:
correcting, in case at least a partial section of the object road shape data is absent on the digital map, a position or shape of the absent section of the object road shape data, with reference to the assistance shape data.

11. A positional information creation method of creating the position informational of a digital map, comprising the steps of:
creating object road shape data which is shape data of a transmission object road; and
adding assistance shape data which shape data of a connection road to be connected to the object road, to the object road shape data thereby to create position codes.

12. A positional information creation method according to claim 11,
wherein the assistance shape data are added to the object road shape data, in case a connection angle between the connection road and the object road is within a predetermined angle or in case the shape of the connection road from the connection position to a predetermined position and the shape of the object road are parallel and similar to each other.

13. A positional information creation method according to claim 11,
wherein the assistance shape data are added to the object road shape data in case another parallel and similar road is present in the periphery of the object road.

14. A positional information creation method according to claim 13, further comprising the step of:
discriminating the connection road with at least one of connection position, shape and attribute thereof.

15. A positional information creation method according to claim 11, further comprising the step of:
incorporating, in case the object road includes a section having a high probability of being absent from a position codes transmission destination, the connection road to be connected to the section and having a high probability of being present in the transmission destination, as assistance shape data into position codes.

16. A positional information creation method according to claim 15, further comprising the step of:
discriminating the probability of the object road being present at the transmission destination, with the opening year of the road.

17. A positional information creation method according to claim 15, further comprising the step of:
discriminating the probability of the object road being present at the transmission destination, with the type of the road.

18. A positional information decoding method of decoding positional information of a digital map, comprising the steps of:
receiving position codes composed of object road shape data of a transmission object road and assistance shape data of a road to be connected to the object road;
separating the object road shape data and the assistance shape data; and
specifying the object road on the digital map with reference to the object road shape data.

19. A positional information specifying method of using information, which includes at least shape data of a road and assistance shape data of a road to be connected to the road, to specify a position on a digital map on a reception side.

20. A positional information transmission method of transmitting positional information from a transmission side to a reception side provided with a digital map, comprising the steps of:
(A) creating, on the transmission side, object road shape data of a transmission object road and a branch shape data of a branch intersecting with or branching from the object road;
(B) transmitting the object road shape data and the branch shape data from the transmission side to the reception side; and
(C) specifying, on the reception side, the object road on the digital map with reference to the object road shape data and the branch shape data.

21. A positional information transmission method according to claim 20,
wherein the (C) step includes:
(c1) a first location identification step of selecting an object road candidate for the object road from the digital map with reference to the object road shape data; (c2) a second location identification step of selecting a branch candidate for the branch from the digital map with reference to the branch shape data, with the assumption that the object road candidate is the object road;
(c3) a step of repeating the (c1) step and the (c2) step to select a plurality of combinations of the object road candidate and branch candidate; and
(c4) a step of finally selecting the object road candidate to be the object road, from the plural combinations.

22. A positional information transmission method according to claim 21,
wherein the (c4) step includes:
a step of deciding similarities between the shapes of the object road candidate and the branch candidate and the original shapes of the object road and the branch; and
a step of finally selecting the object road candidate to be the object road, on the basis of the decision result.

23. A positional information transmission method according to claim 21,
wherein, in case the branch shape data are created at the (A) step on the basis of a relative position relation, reference data to refer to the road shape data are included in the branch shape data.

24. A positional information transmission method according to claim 23,
wherein at the (c2) step, the branch candidate is selected using the reference data.

25. A positional information transmission method according to claim 21,
wherein the (c4) step includes:
(1) a step of calculating a first vector between a point of the object road and a point of the branch which are equidistance from a point of intersection between the original shapes of the object road and the branch;
(2) a step of repeating the first vector calculating step at plural distances from the point of intersection, to acquire a plurality of first vectors;
(3) a step of calculating a second vector between a point of the object road candidate a point of the branch candidate which are equidistance from a point of intersection between the object road candidate and the branch candidate;
(4) a step of repeating the second vector calculating step at plural distances from the point of intersection and in every plural combinations, to acquire a plurality of second vectors; and
(5) a step of calculating differences between the plural first vectors and the plural second vectors in every the combinations, to finally select the object road candidate of the combination the smallest in the difference, as the object road.

26. A positional information transmission method according to claim 21,
wherein the (c4) step includes:
(1) a step of calculating a first angle made between the object road of the original shape and the branch of the original shape;
(2) a step of calculating a second angle between the object road candidate and the branch candidate in every combinations; and
(3) a step calculating differences between the first angle and the second angle in every combinations, to finally select the object road candidate of the combination the smallest in the difference, as the object road.

27. A positional information transmission method according to claim 21, further comprising:
a step of searching, after the (c1) step and the (c2) step, a branching point, at which the branch candidate branches from the object road candidate, on the digital map; and
a step of correcting the shape of the branch candidate to a shape to branch at the branching point with respect to the object road candidate.

28. A positional information transmission method according to claim 21, further comprising:
a step of searching, after the (c1) step and the (c2) step, a branching point, at which extensions of the object road candidate and the branch candidate branch, on the digital map; and
a step of correcting the shape of the branch candidate to the shape to branch at the branching point with respect to the object road candidate.

29. A positional information transmission method according to claim 27,
wherein a position of event information relating to the object road shape data and the branch shape data is corrected with reference to the corrected shape of the branch candidate.

30. A positional information transmission method according to claim 20,
wherein in the case an angle between a road intersection with or branching from the object road and the object road is within a predetermined angle range and the shape of the road at a predetermined distance from the intersecting position or the branching position is similar to the shape of the object road, the road is set as the branch.

31. A program product for causing an information serving device to provide positional information for a digital map, comprising:
a recording medium; and
a program recorded in the recording medium,
wherein the program causes the information serving device to execute:
the procedure for extracting object road shape data corresponding to a transmission object road, from a digital map database;
the procedure for extracting branch shape data corresponding to a branch intersecting with or branching from the object road, from the digital map database; and
the procedure for transmitting the object road shape data and the branch shape data extracted, to the outside.

32. A program product for causing an information application device to receive and utilize positional information for a digital map, comprising:
a recording medium; and
a program recorded in the recording medium,
wherein the program causes the information application device to execute:
the procedure for accepting object road shape data of an object road and branch shape data corresponding to a branch intersecting with or branching from the object road;
the procedure for selecting an object road candidate from a digital map database with reference to the object road shape data;
the procedure for selecting a branch candidate from the digital map database with reference to the branch shape data; and
the procedure for finally selecting the object road candidate to be the object road, with reference to the object road candidate and the branch candidate.

33. A positional information transmission system for a digital map, comprising: (A) an information providing device; and (B) an information application device,
wherein the (A) information providing device includes:
an object road shape data extraction unit for extracting an object road shape data corresponding to a transmission object road, from a first digital map database; and
a branch shape data extraction unit for extracting branch shape data corresponding to a branch intersecting with or branching from the object road from the first digital map database, and
wherein the (B) information application device includes:
an object road candidate selection unit for selecting an object road candidate from a second digital map database with reference to the object road shape data provided from the information providing device;
a branch candidate selection unit for selecting a branch candidate from the second digital map database with reference to the branch shape data provided from the information providing device; and
an object road decision unit for finally selecting the object road candidate to be the object road, with reference to the object road candidate and the branch candidate.

34. An information providing device for providing positional information for a digital map, comprising:
a digital map database;
an object road shape data extraction unit for extracting an object road shape data corresponding to a transmission object road, from a digital map database;
a branch shape data extraction unit for extracting branch shape data corresponding to a branch intersecting with or branching from the object road, from the digital map database
a shape data transmission unit for transmitting the object road shape data and the branch shape data extracted, to the outside.

35. An information application device for receiving and utilizing positional information for a digital map, comprising:
a digital map database;
a shape data reception unit for receiving object road and branch shape data corresponding to a branch intersecting with or branching from the object road, from the outside;
an object road candidate selection unit for selecting an object road candidate from the digital map database with reference to the object road shape data;
a branch candidate selection unit for selecting a branch candidate from the digital map database with reference to the branch shape data; and
an object road determination unit for finally selecting the object road candidate to become the object road, with reference to the object road candidate and the branch candidate.

36. (canceled)

37. (canceled)
